(19) United States
(12) Patent Application Publication
(10) Pub. No.: US 2005/0021522 A1
(43) Pub. Date: Jan. 27, 2005

(54) Apparatus, method and computer readable medium for evaluating a network of entities and assets

(76) Inventors: Mark Herman, Potomac, MD (US); Melissa Hathaway, Vienna, VA (US); Melvin Sobotka, Ellicott City, MD (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 10/845,423

(22) Filed: May 14, 2004

Related U.S. Application Data
(60) Provisional application No. 60/470,932, filed on May 16, 2003.

(51) Int. Cl. G06F 7/00

(52) U.S. Cl. 707/10; 707/104.1

(57) ABSTRACT

The present invention is directed to an apparatus, method and computer apparatus for evaluating a network of entities and assets.

### Cross Reference to Related Patent Applications

This patent application claims the benefit of U.S. Provisional Patent Application No. 60/470,932, entitled “Method and Apparatus for Evaluating Complex Networks”, filed May 16, 2003, the disclosure of which is herein specifically incorporated in its entirety by reference.

### REFERENCE TO COMPACT DISC APPENDIX

A compact disc appendix including a computer program listing is filed herewith. The compact disc appendix includes the computer source code of a preferred embodiment of the present invention. Other embodiments of the present invention may be implemented using other computer code, using dedicated electronic hardware, using a combination of these, or otherwise. The contents of the compact disc appendix are incorporated herein in their entirety and are to be considered to be part of the disclosure of this specification.

### BACKGROUND OF THE INVENTION

1. Field of the Invention

The present invention relates to the evaluation of networks. In particular, the present invention is directed to evaluating relationships among entities and assets that are within a network.

2. Description of Related Art

There are tools for analyzing networks that exist in several functional areas, which include social network analysis, systems architecture, critical infrastructures, and geographical information systems.

Social Network Analysis tools allow the user to visualize the influence that existing relationships bestow and also allows for the use of computational mathematics to quantify that influence. Some programs do not allow for visualization beyond a socio-matrix, while others are nothing more than visualizations.

Systems Architecture tools are used to create a logical view of how various systems interconnect in a process. They may provide diagrams of complex systems, the relevant infrastructure, and a database feature to embed more information relating to those systems. Critical Infrastructure analysis tools graphically depict the physical array of infrastructures (telecommunication, power, and transportation) to show interconnectivity and the logical and physical dependence of a given location. Telecommunication, power, and transportation infrastructure networks are defined and analyzed using known engineering, reverse engineering, and operations research principles. Analysts create visualizations of these networks on a geospatial backdrop and examine the vulnerability, survivability, and connectivity of these networks.

Geographic Information Systems (GIS) software allows users to visualize, manipulate and layer different types of geospatial information. Such software is useful for demographics, location based services, weather forecasting, land use, and infrastructure analysis. Each GIS software solution provides the capability for users to map, visualize, and analyze geospatial data. Some of the following GIS products also provide statistical calculations and other geo-processing capabilities. They have the capability to interface to or be integrated into custom software applications.

What is needed are tools that combine the functionality of the above-mentioned tools so as to provide the capability to analyze information relating to entities and assets within a network having a geospatial reference.

### SUMMARY OF THE INVENTION

In accordance with an exemplary embodiment of the invention, an apparatus is provided for evaluating a network of one or more entities and one or more assets. The apparatus includes at least a memory and one or more processors. The memory stores information pertaining to at least a first entity in the network and at least a first asset in the network. The information may be included within a database. In addition, one or more items of the information may have a time stamp associated therewith, the items including one or more attributes.

The information includes a first group of attributes corresponding to the first entity and a second group of attributes corresponding to the first asset. The first group of attributes includes at least a first attribute identifying the first entity and a second attribute identifying a physical location of the first entity. By way of example, the first attribute of the first group of attributes may identify the name of the first entity and the second attribute of the first group of attributes may identify a country of operation of the first entity. The second group of attributes includes a first attribute identifying the first asset and a second attribute identifying a physical location of the first asset.

The first group of attributes corresponding to the first entity may also include a third attribute identifying at least one asset with which the first entity is linked, the asset being the first asset. The second group of attributes corresponding to the first asset may also include a third attribute identifying at least one entity, such as the first entity, with which the first asset is linked.

The information may also pertain to a second entity in the network and a second asset in the network. In this regard, the information may include a third group of attributes corresponding to the second entity and a fourth group of attributes corresponding to the second asset. The third group of attributes includes at least a first attribute identifying the second entity and a second attribute identifying a physical location of the second entity. By way of example, the first attribute of the third group of attributes may identify the name of the second entity and the second attribute of the third group of attributes identifies a country of operation of the second entity. The fourth group of attributes includes a first attribute identifying the second asset and a second attribute identifying a physical location of the second asset. By way of example, the first attribute of the fourth group of attributes identifies the name of the second asset and the second attribute of the fourth group of attributes identifies a coordinate position of the second asset. The coordinate position of the second asset is defined in terms of its latitude and longitude.

The first group of attributes corresponding to the first entity may also include a third attribute identifying at least one asset with which the first entity is linked, the asset being either the first asset or the second asset for example.

The first group of attributes may include an additional attribute identifying a country of origin of the first entity. The first group of attributes may also include an additional attribute identifying a city in which the first entity is located.

The first group of attributes corresponding to the first entity may also include one or more of the following: an attribute identifying an alias of the first entity, an attribute identifying a role assumed by the first entity, an attribute identifying a classification status of the first entity, an attribute identifying a data source from which intelligence on the first entity was gathered, and an attribute providing descriptive information relating to the first entity.

The first group of attributes corresponding to the first entity may also include one or more association attributes defining an association between the first entity and at least one other entity, the one other entity being the second entity for example. The association attributes may include an association attribute defining a type of the association between the first entity and the second entity. The association attributes may include an association attribute defining strength of the association between the first entity and the second entity. The association attributes may include an association attribute defining a direction type of the association between the first entity and the second entity, the direction type being one of the following: (i) a first direction from the first entity to the second entity, (ii) a second direction from the second entity to the first entity and (iii) both the first and second directions. The association attributes may include an association attribute providing a description of the type of the association between the first entity and the second entity.

The second group of attributes corresponding to the first asset may also include a third attribute identifying at least one entity with which the first asset is linked, the entity being either the first entity or the second entity for example. The second group of attributes corresponding to the first asset may also include a third attribute identifying at least one other asset with which the first asset is linked, the one other asset being the second asset.

The first attribute of the second group of attributes may identify the name of the first asset and the second attribute of the second group of attributes may identify a coordinate position of the first asset. The coordinate position of the first asset may be defined in terms of its latitude and longitude. The second group of attributes corresponding to the first asset may also include one or more of the following: an attribute identifying a type of the first asset, and an attribute providing descriptive information relating to the first asset.

The third group of attributes corresponding to the second entity may also include a third attribute identifying at least one asset with which the third entity is linked, the asset being either the first asset or the second asset for example. The third group of attributes may include an additional attribute identifying a country of origin of the second entity. The third group of attributes may include an additional attribute identifying a city in which the second entity is located.

The third group of attributes corresponding to the second entity may also include one or more of the following: an attribute identifying an alias of the second entity, an attribute identifying a role assumed by the second entity, an attribute identifying a classification status of the second entity, an attribute identifying a data source from which intelligence on the second entity was gathered, and an attribute providing descriptive information relating to the second entity.

The fourth group of attributes corresponding to the second asset may also include a third attribute identifying at least one entity with which the second asset is linked, the entity being either the first entity or the second entity. The fourth group of attributes corresponding to the second asset may also include one or more of the following: an attribute identifying a type of the second asset, and an attribute providing descriptive information relating to the second asset.

The apparatus is programmed to access the memory and retrieve at least a first subset of the information pertaining to the first entity and a second subset of the information pertaining to the first asset. The first subset of the information includes at least the first group of attributes corresponding to the first entity, and the second subset of the information includes at least the second group of attributes corresponding to the first asset. The first subset of the information and the second subset of the information are retrieved from the memory in accordance with specified criteria.

The apparatus may also be programmed to access the memory and retrieve at least a third subset of the information pertaining to the second entity and a fourth subset of the information pertaining to the second asset. The third subset of the information includes at least the third group of attributes corresponding to the second entity, and the fourth subset of the information includes at least the fourth group of attributes corresponding to the second asset. The third subset of the information and the fourth subset of the information are retrieved from the memory in accordance with specified criteria.

The apparatus also has a display and may be programmed to display one or more first indicia each representative of the first subset of the information pertaining to the first entity and one or more second indicia each representative of the second subset of the information pertaining to the first asset. The apparatus may also be programmed to display one or more third indicia each representative of the third subset of the information pertaining to the second entity and fourth indicia representative of the fourth subset of information pertaining to the second asset.

The apparatus may be programmed to display the one or more first indicia representative of the first subset of the information pertaining to the first entity and the one or more second indicia representative of the second subset of the information pertaining to the first asset in multiple virtual layers, wherein any number of the virtual layers may be displayed on the display at any one time. The virtual layers may include a first group of virtual layers having at least a first virtual layer. The one or more first indicia may be displayed in the first group of virtual layers. By way of example, the first virtual layer of the first group of virtual layers may display one of the first indicia which may represent the second attribute of the first group of attributes included within the first subset of the information.

The virtual layers may include a second group of virtual layers having at least a first virtual layer. The one or more second indicia may be displayed in the second group of virtual layers. Within the first virtual layer of the second group of virtual layers may be displayed one of the second indicia representing the second attribute of the second group of attributes included within the second subset of the information. The virtual layers may include a third group of virtual layers having at least a first virtual layer in which is displayed one of the first indicia representing the third attribute of the first group of attributes included within the first subset of the information. Alternatively, within the third group of virtual layers having at least a first virtual layer may be displayed one of the second indicia representing the third attribute of the second group of attributes included within the second subset of the information.

The apparatus may also be programmed to display at one time the one or more first indicia representative of the first subset of the information pertaining to the first entity, the one or more second indicia representative of the second subset of the information pertaining to the first asset, the one or more third indicia representative of the third subset of the information pertaining to the second entity and the fourth indicia representative of the fourth subset of the information pertaining to the second asset in a plurality of virtual layers, wherein any number of layers of the plurality of virtual layers may be displayed on the display at any one time.

By way of example, the virtual layers may include a first group of virtual layers having at least a first virtual layer. The one or more first indicia and the one or more third indicia may be displayed in the first group of virtual layers. By way of example, within the first virtual layer of the first group of virtual layers may be displayed one of the first indicia representing the second attribute of the first group of attributes included within the first subset of the information and one of the third indicia representing the second attribute of the third group of attributes included within the third subset of information. The plurality of virtual layers may also include a second group of virtual layers having at least a first virtual layer. The second indicia and fourth indicia may be displayed in the second group of virtual layers. By way of example, within the first virtual layer of the second group of virtual layers is displayed one of the second indicia representing the second attribute of the second group of attributes included within the second subset of the information and one of the fourth indicia representing the second attribute of the fourth group of attributes included within the fourth subset of the information.

The present invention may also be embodied in a method a computer readable medium.

### BRIEF DESCRIPTION OF THE DRAWINGS

FIG. 1 is a block diagram of an overall system in which embodiments of the present invention may be implemented.

FIG. 2 shows the Startup screen of the preferred embodiment of the present invention.

FIG. 3 shows an aspect of the Startup screen of the preferred embodiment of the present invention that relates to managing a database.

FIG. 4 shows an aspect of the Startup screen of the preferred embodiment of the present invention that relates to projects.

FIG. 5 shows an aspect of the Startup screen of the preferred embodiment of the present invention that relates to social networks.

FIG. 6 shows the Main Menu Bar of the preferred embodiment of the present invention.

FIG. 7 shows the Data Toolbar of the preferred embodiment of the present invention.

FIG. 8 shows the Map Functions Toolbar of the preferred embodiment of the present invention.

FIG. 9 shows the Map Tools Toolbar of the preferred embodiment of the present invention.

FIG. 10 shows the Edit User Preferences Interface of the preferred embodiment of the present invention.

FIG. 11 shows an aspect of the New Person Wizard of the preferred embodiment of the present invention that relates to a General Information step.

FIG. 12 shows an aspect of the New Person Wizard of the preferred embodiment of the present invention that relates to a Roles step.

FIG. 13 shows an aspect of the New Person Wizard of the preferred embodiment of the present invention that relates to an Alias step.

FIG. 14 shows an aspect of the New Person Wizard of the preferred embodiment of the present invention that relates to a Communication Devices step.

FIG. 15 shows an aspect of the New Person Wizard of the preferred embodiment of the present invention that relates to an Assets step.

FIG. 16 shows an aspect of the New Person Wizard of the preferred embodiment of the present invention that relates to an Associations step.

FIG. 17 shows an aspect of the New Person Wizard of the preferred embodiment of the present invention that relates to a Summary step.

FIG. 18 shows the Choose Person Interface of the preferred embodiment of the present invention.

FIG. 19 shows an aspect of the New Asset Wizard of the preferred embodiment of the present invention relating to a General Information step.

FIG. 20 shows another aspect of the New Asset Wizard of the preferred embodiment of the present invention relating to a General Information step.

FIG. 21 shows the Choose Asset Interface of the preferred embodiment of the present invention.

FIG. 22 shows an aspect of the New Communication Devices Wizard Interface of the preferred embodiment of the present invention relating to a General Information step.

FIG. 23 shows the Choose Communication Device Interface of the preferred embodiment of the present invention.

FIG. 24 shows an aspect of the Import Records Wizard of the preferred embodiment of the present invention relating to the importing of records for persons.

FIG. 25 shows an aspect of the New Project Wizard of the preferred embodiment of the present invention relating to a General Information step.

FIG. 26 shows an aspect of the New Project Wizard of the preferred embodiment of the present invention relating to a Persons step.

FIG. 27 shows an aspect of the New Project Wizard of the preferred embodiment of the present invention relating to an Assets step.

FIG. 28 shows an aspect of the New Project Wizard of the preferred embodiment of the present invention relating to a Summary step.

FIG. 29 shows the Choose Project Interface of the preferred embodiment of the present invention.

FIG. 30 shows a map displaying entities and assets in accordance with a preferred embodiment of the present invention.

FIG. 31 shows the Map Legend of the preferred embodiment of the present invention.

FIG. 32 shows the View Table Interface of the preferred embodiment of the present invention.

FIG. 33 shows the Generate Input Files Interface of the preferred embodiment of the present invention.

### DESCRIPTION OF PREFERRED EMBODIMENTS OF THE INVENTION

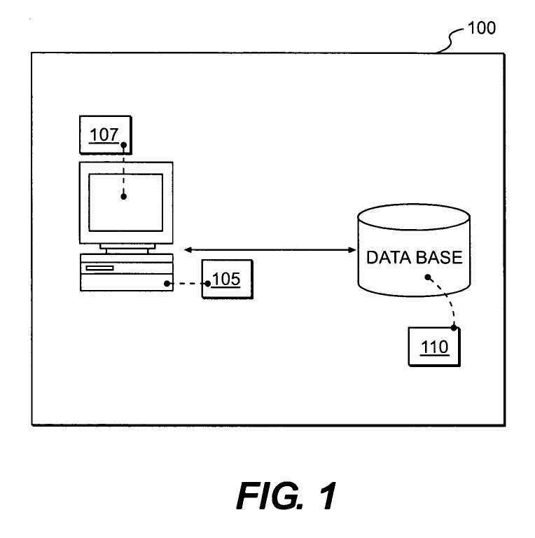

The present invention may be implemented in a computer system 100, as shown in FIG. 1. The computer system 100 includes at least one computer 105 having one or more processors (not shown) coupled to memory (not shown). The computer 105 may be accessible to a user directly or indirectly via one or more networks, such as a local area network, wide area network, wireless network, or the Internet. If the computer is directly accessible, the user may interact with the computer 105 via input output devices (not shown), such as a keyboard, mouse or trackball. In addition, the computer 105 may have a display 107, such as a monitor, LCD display or plasma display, which displays information to the user. The computer 105 may also be coupled to a printer (not shown) for printing information. The computer 105 stores in memory the software (and corresponding data) that is used to implement the present invention. Also stored in the memory of the computer 105 are the data relied upon by the software application of the present invention. Preferably, the computer 105 is coupled to a database 110 (or multiple databases), such as a relational database. The database 110 stores information relating to entities (including persons) and assets (e.g., communication assets, including devices such as servers, junctions and routers) used by one or more of those entities. By way of example, the database 110 may reside on the computer 105 or may be on a database server (not shown) that is accessible via one or more networks. Software applications may be stored on various electronic media, such as hard drives, optical drives, floppy disks, flash memory, random access memory, read only memory, or other computer readable media known in the art.

The preferred embodiment of the present invention is implemented as a software application (or applications) contained in a computer readable medium that includes at least three components: (i) a database component for managing data entry and editing, (ii) a software component (the “project component”) for establishing projects that are used to map data to analyze physical and logical relationships among entities and assets, and (iii) a software component for exporting data relating to social networks into files (e.g., Inflow 3.0 input files) that may be used to analyze those relationships. The display 107 may be used to display the physical and logical networks of associations among those entities and assets.

The software application of the preferred embodiment was developed for use in a wide variety of applications. By way of example, the present invention may be employed to monitor organizational behavior (including that of political organizations), financial institutions, terrorists, international arms trading, illegal immigrants, money laundering, drug trafficking, counterfeit goods, gray or black market goods, competitive intelligence, technological developments and transfers, computer hacking, and the spread of communicable diseases.

The preferred embodiment of the present invention may be coded, for example, using Microsoft Visual Basic 6.0 Service Pack 5 along with ESRI ArcObjects 8.2 library using a Microsoft Access 2000 database.

The database component of the preferred embodiment allows a user to add, edit, and delete information relating to entities and assets to and from the database through the use of various wizards and interfaces. The present invention is based on evaluating information relating to entities, such as persons, and assets (e.g., communication devices). Adding additional information relating to new persons and assets to the database (e.g., database 110) may be done via, for example, wizards, which are software components that take the user step-by-step through intuitive interfaces to enter data relevant to the new asset and/or entity. Separate interfaces are used to list each asset or entity in the database. Interacting with these lists, the user can access edit interfaces make changes and additions to any data entered about the asset or entity, or delete that data entirely from the database.

The user may gather information pertaining to assets and/or entities from a variety of sources. For information residing on computer networks, such as the Internet, a software program, such as a search engine, may be used to gather information residing on the computer network.

A user of the present invention may create, edit, map, or delete information concerning projects from the database using the project component including a wizard and various interfaces. A project is a collection of persons and assets and their relationships, which the user will analyze through the use of, for example, a Geographical Information System (GIS) component, which is associated with the project component. A user creates a new project via a wizard of the project component that takes the user step-by-step through intuitive interfaces to choose the persons and assets the user would like to view on a map. The GIS component plots the selected persons and assets, as well as their first-tier relationships for further analysis by the user. Interacting with a list of projects, the user can access interfaces where the user can edit a project, or delete the project entirely from the database.

The software component (the “export component”) for exporting data concerning social networks generates input files for other software applications. By way of example, the export component may generate input files for Inflow 3.0 and may also launch the Inflow 3.0 application. A user will be prompted to select persons to add to the input file. Thereafter, the export component may generate two files, nodes and links, to use in Inflow 3.0 for social network analysis.

Components of the Preferred Embodiment

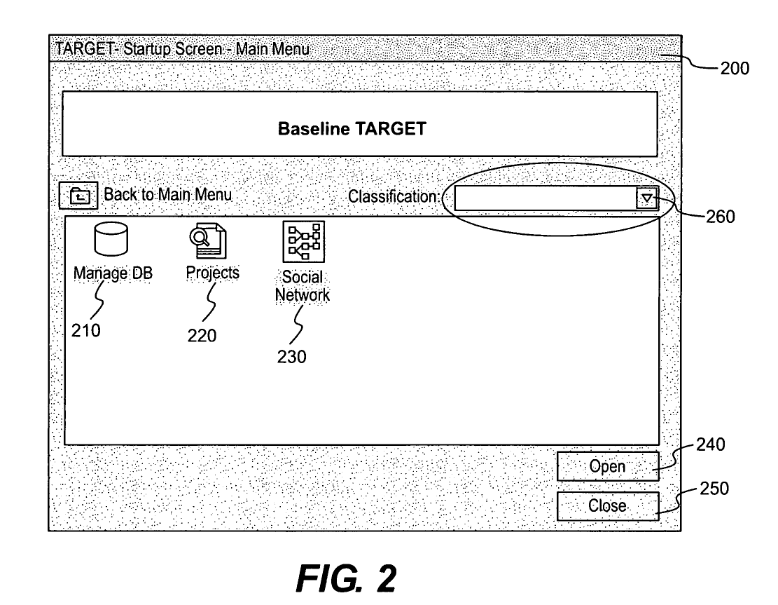

Upon starting the software application of the preferred embodiment on a computer (e.g., computer 105), the Startup Screen (Main Menu) 200 shown in FIG. 2 will be the first screen displayed on the display 107. The Startup screen 200 provides the user with access to all of the capabilities of the software application of the preferred embodiment. In accordance with the preferred embodiment, the user may choose the classification level of the user's work using a classification dropdown box 260 just below a title bar of the Startup screen 200. The selection of a classification from the Startup screen 200 may be made mandatory, such that the classification must be selected before the software application will allow the user to continue. Once chosen, the classification will be displayed in red uppercase letters at the top of every interface during the remainder of the current session that the software application of the preferred embodiment is being used, and the user will have access to every component in that software application. This classification can be changed at any time during the user's session by returning to the Startup screen 200 and choosing a different classification from the dropdown box.

As shown in FIG. 2, the Startup screen 200 of the preferred embodiment provides the user with three icons that they may choose, including the “Manage DB” icon 210, the “Projects” icon 220, and the “Social Network” icon 230. The “Manage DB” icon 210 permits the user to access interfaces where the user can add, edit, or delete persons and assets (including communication devices). The “Projects” icon 220 permits the user to access interfaces where the user can add, edit, map, or delete projects. The “Social Network” icon 230 permits the user to access an interface to generate Inflow 3.0 input files and launch Inflow 3.0.

The user may choose one of the icons 210, 220, or 230 and then select the “Open” button 240, or double-click on that icon 210, 220, 230. The user may close the Startup screen at any time by clicking the “Close” button 250. This will also allow the user to use the software application of the preferred embodiment through the “Main” window. To return to the Startup screen 200 once it has been closed, the user must go to the menu bar and choose the “File-Startup” screen, or click “Startup” screen 200 in a “Map Functions” toolbar.

In the preferred embodiment, the Startup screen 200 will not allow the user to do anything until the user chooses a “Classification” from the drop down menu 260, as shown in the circled portion of FIG. 2. However, this feature need not be implemented in all embodiments of the present invention.

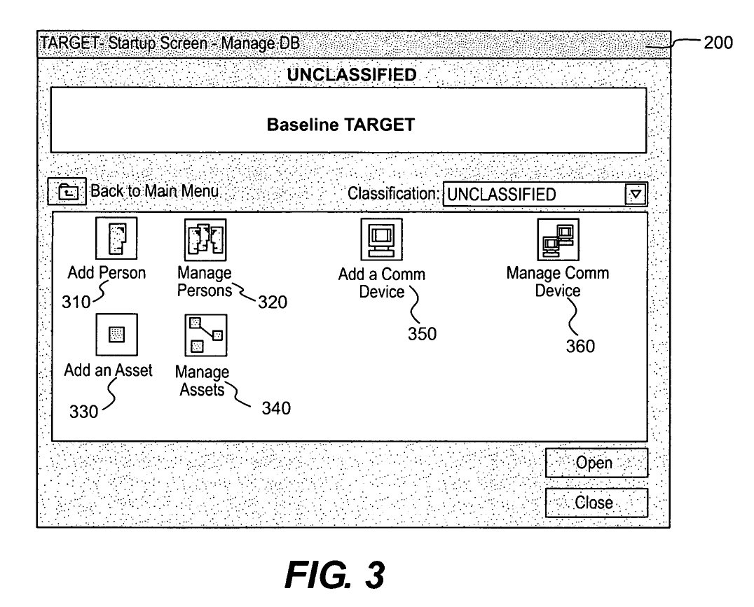

After choosing the “Manage DB” icon 210, the “Startup” screen (Manage DB) 200 is then populated with six new icons, as shown in FIG. 3. These six icons include the “Add a Person” icon 310, the “Manage Persons” icon 320, the “Add an Asset” icon 330, the “Manage Assets” icon 340, the “Add a Comm Device” icon 350, and the “Manage Comm Devices” icon 360. The “Add a Person” icon 310 opens the “Add New Person” wizard. The “Manage Persons” icon 320 opens the “Choose Person” wizard, from which the user can edit existing persons or add a new person to the database. The “Add an Asset” icon 330 opens the “Add New Asset” wizard. The “Manage Assets” icon 340 opens the “Choose Asset” wizard, from which the user can edit existing assets or add a new asset to the database. The “Add a Comm Device” icon 350 opens the “Add New Comm Device” wizard. The “Manage Comm Devices” icon 360 opens the “Choose Comm Device” wizard, from which the user can edit existing comm device or add a new comm device to the database.

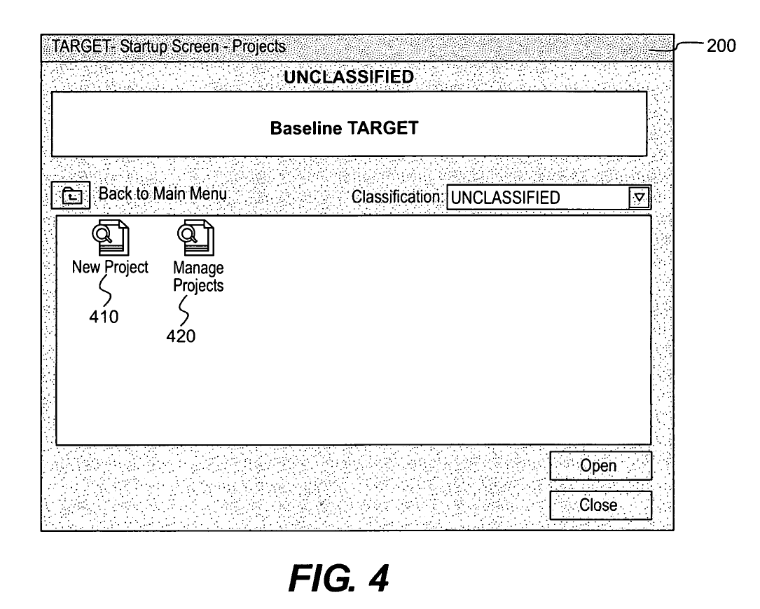

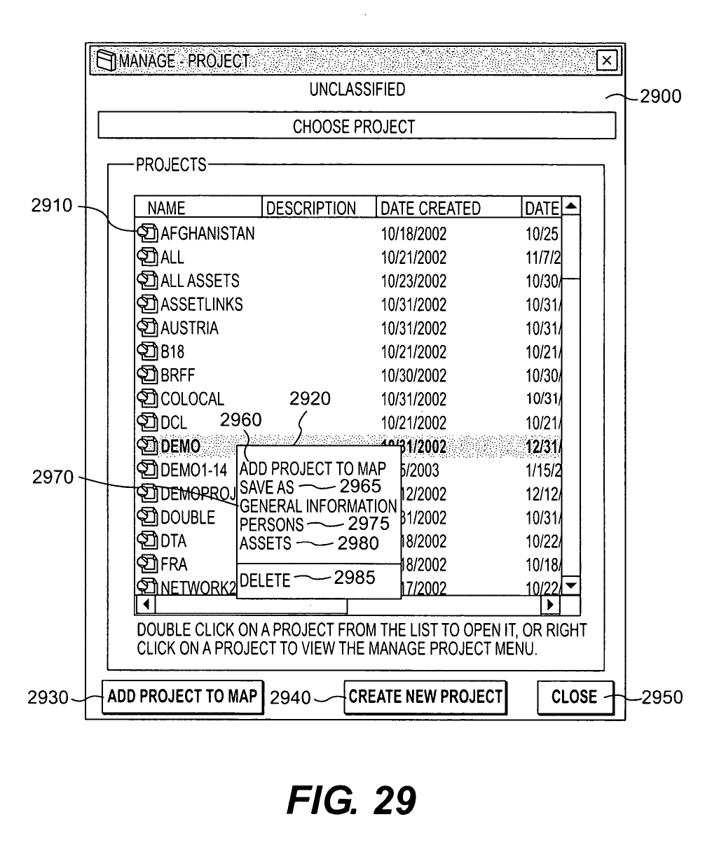

After choosing “Projects” icon 220, the Startup screen (Projects) 200 is populated with two new icons, as shown in FIG. 4. These two icons include the “New Project” icon 410 and the “Manage Projects” icon 420. The “New Project” icon 410 opens the “Add New Project” wizard. The “Manage Projects” icon 420 opens the “Choose Project” interface 2900 (shown in FIG. 29), from which the user can edit or map an existing project or add a new project to the database.

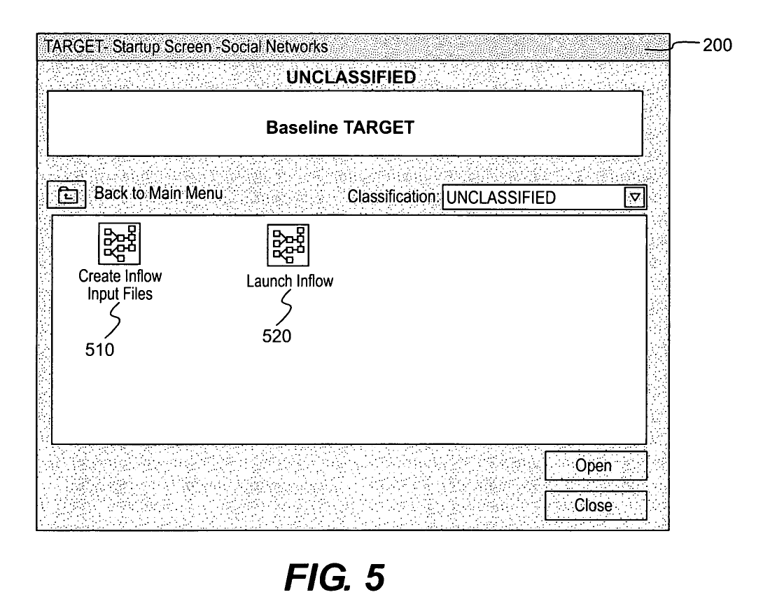

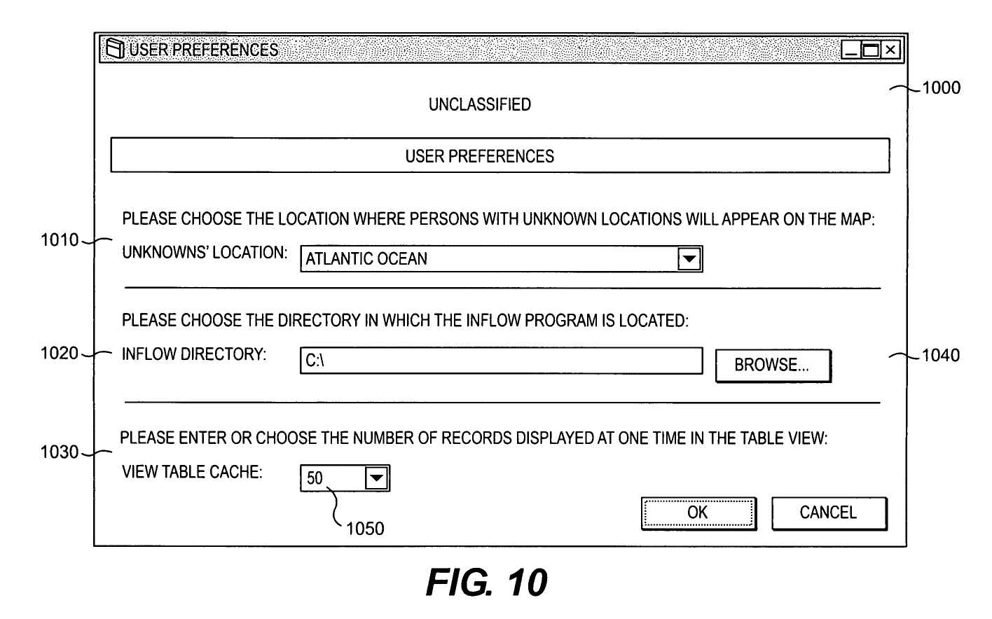

After choosing the “Social Networks” icon 230, the “Startup” screen (Social Networks) 200 is then populated with two new icons, as shown in FIG. 5. These two icons include the “Create Inflow Input Files” icon 510 and the “Launch Inflow” icon 520. The “Create Inflow Input Files” icon 510 opens an interface that allows the user to generate input files for use in Inflow 3.0. The “Launch Inflow” icon 520 opens Inflow 3.0 from the Inflow Directory set in the “Inflow Directory” dropdown menu 1020 of the “User Preferences” interface 1000 (shown in FIG. 10).

The software application of the preferred embodiment of the present invention interacts with the user through five types of general interfaces. These general interfaces include a Menu Bar, Toolbars, Wizards, Interfaces and the GIS component.

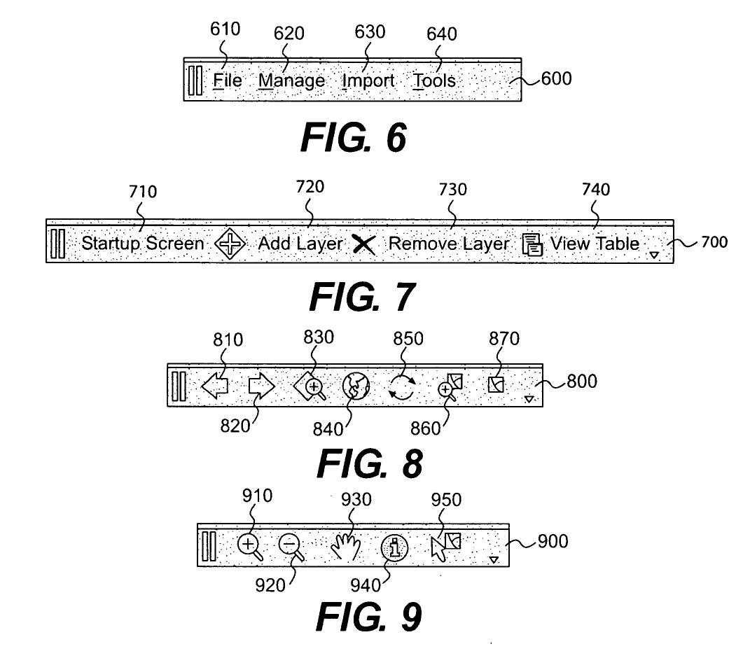

As shown in FIG. 6, the software application of the preferred embodiment implements a main menu bar 600, which is located just below the software application's title bar. The main menu bar 600 allows access to all of the applications functions, including adding data, editing data, manipulating the map, and setting user preferences. The main menu bar 600 includes four drop down menus, including a “File” menu 610, a “Manage” menu 620, an “Import” menu 630, and a “Tools” menu 640.

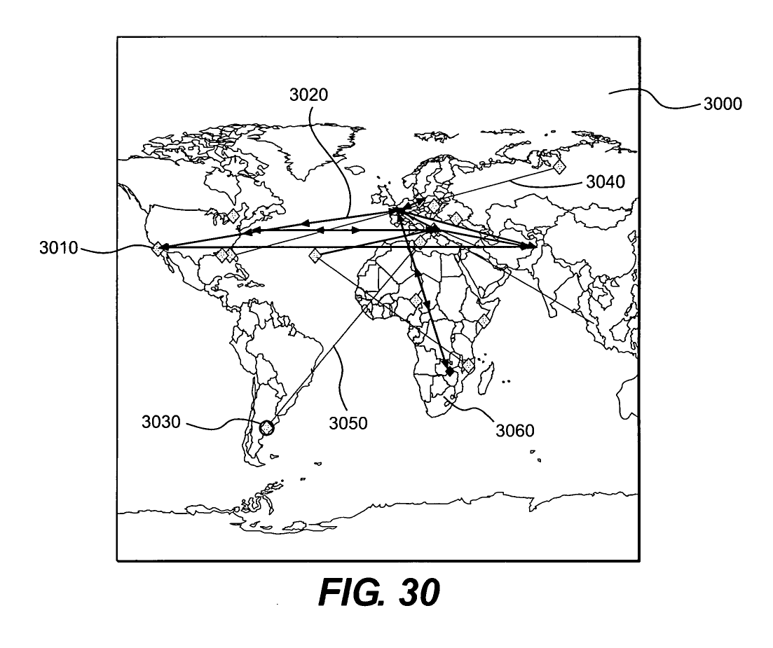

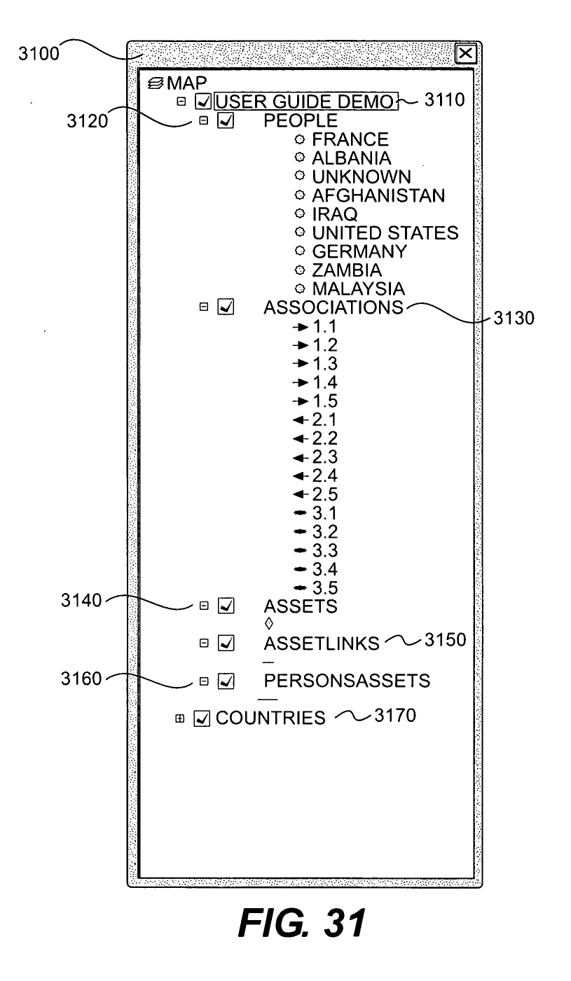

The “File” drop down menu 610 allows the user to perform miscellaneous actions within the software application of the preferred embodiment. The “File” drop down menu 610 provides the user with six options, including a “Remove Layer” option, a “Startup Screen” option, a “Generate Inflow Input Files” option, a “Launch Inflow” option, a “Hide/Show Map” option, and an “Exit” option. The “Remove Layer” option removes the layer selected in the legend 3100 (shown in FIG. 31) from the map 3000 (shown in FIG. 30). The “Startup Screen” option opens the software applications startup screen. The “Generate Inflow Input Files” option opens an interface that allows the user to generate input files for use in Inflow 3.0. The “Launch Inflow” option starts Inflow 3.0 from the Inflow directory selected via the User's Preferences interface. The “Hide/Show Map” option hides or shows the map, depending on its current status in the Main window. The “Exit” option closes the software application of the preferred embodiment.

The “Manage” drop down menu 620 allows the user to manage the database employed with the present invention. The “Manage” drop down menu provides the user with four options, including a “Persons” option, an “Assets” option, a “Comm Devices” option and a “Projects” option. The “Persons” option which opens the “Choose Person” interface, from which the user can edit existing persons or add a new person to the database. The “Assets” option opens the “Choose Asset” interface, from which the user can edit existing assets or add a new asset to the database. The “Comm Devices” option opens the “Choose Comm Device” interface, from which the user can edit existing comm devices or add a new comm device to the database. The “Projects” option opens the “Choose Project” interface, from which the user can edit and/or map existing projects or add a new project to the database.

The “Import” dropdown menu 630 allows the user to either import individual records or import an entire database of records. The user should note that the database used in each method should have the same schema, tables, and field names as the database to work optimally.

The “Tools” dropdown menu 640 provides the user with several map function options, as well as access to the “Edit User Preferences” interface. The map function options include a “Zoom to Layer” option, a “Full Extent” option, a “Previous Extent” option, and a “Next Extent” option. The “Zoom to Layer” option zooms the map to the extent of the layer selected in the legend. The “Full Extent” option zooms the map to view all objects on the map. The “Previous Extent” option returns the map to the extent seen prior to the current extent. The “Next Extent” option returns the map to the next extent viewed in a sequence of map manipulations after the “Previous Extent” function has been used. The “Tools” dropdown menu 640 also gives access to the “User Preferences” interface.

The software application of the preferred embodiment implements three tool bars. These include a “Data” tool bar, a “Map Functions” tool bar, and a “Map Tools” tool bar. The “Data” tool bar provides access to functions that permit the user to manipulate data on the map. The “Map Functions” tool bar provides access to functions that permit the user to manipulate the map. The “Map Tools” toolbar provides tools that allow the user to manipulate the map.

The “Data” tool bar 700 shown in FIG. 7 provides the user with access to four function buttons to help the user view or manipulate the data on the map 3000 (shown in FIG. 30). These function buttons include the “Startup Screen” button 710, the “Add Layer” button 720, the “Remove Layer” button 730, and the “View Table” button 740. The “Startup Screen” button 710 re-opens the “Startup” screen 200, where a user can access each major component of software application of the preferred embodiment. The “Add Layer” button 720 allows the user to add a stored layer to the map, such as a shape file. The “Remove Layer” button 730 will remove the layer selected in the legend 3100 (shown in FIG. 31) from the map 3000 (shown in FIG. 30). The “View Table” button 740 will open a table populated with the data stored in the layer selected in the Legend.

The “Map Functions” tool bar 800 shown in FIG. 8 provides the user with access to seven function buttons that manipulate the map 3000 (shown in FIG. 30). These function buttons include a “Previous Extent” button 810, a “Next Extent” button 820, a “Zoom to Layer” button 830, a “Full Extent” button 840, a “Refresh” button 850, a “Zoom to Selection” button 860, and a “Clear Selection” button 870. The “Previous Extent” button 810 allows the user to return the map 3000 (shown to FIG. 30) to the extent seen prior to the current extent. The “Next Extent” button 820 allows the user to return the map to the next extent viewed in a sequence of map manipulations after the “Previous Extent” button 810 has been used. The “Zoom to Layer” button 830 allows the user to set the map extent to that of the layer selected in the legend. The “Full Extent” button 840 allows the user to set the map extent to the full extent so that all objects plotted can be viewed. The “Refresh” button 850 allows the user to refresh the map so that it contains the most current data available. The “Zoom to Selection” button 860 allows the user to set the map extent to the smallest extent possible that includes all of the selected features on the map. The “Clear Selection” button 870 allows the user to unselect any feature selected on the map (i.e., remove the cyan highlight).

The Map Tools Toolbar 900 shown in FIG. 9 allows the user to interact with and manipulate the map 3000 (shown in FIG. 30) and its features via the use of five function buttons. These function buttons include a “Zoom-In” button 910, a “Zoom-Out” button 920, a “Pan” button 930, an “Identity” button 940 and a “Select” button 950.

By selecting the “Zoom-In” button 910, the mouse pointer (or any other input device pointer) will appear as a magnifying glass with a plus sign (+) in it. The user can then zoom-in to any part of the map 3000 using one of two methods. The user may click a point on the map 3000 and the map will re-center on this point and zoom in 75% of the current extent. Or the user may click and drag the mouse pointer on the map, which will draw a rectangle on the map 3000. Once the user releases the left mouse button, the map 3000 will zoom-in to the extent of the rectangle drawn by the user.

By selecting the “Zoom-Out” button 920, the mouse pointer will appear as a magnifying glass with a minus sign (−) in it. The user can then zoom-out from the current extent in order to view features not appearing in the current extent. The user clicks a point on the map 3000, and the map 3000 will re-center on this point and zoom-out to an extent 125% larger than the current extent. Alternatively, the user may click and drag the mouse pointer on the map 3000, which will draw a rectangle on the map. Once the user releases the left mouse button, the map 3000 will zoom-out. Note that the smaller the rectangle drawn, the farther the map 3000 will zoom out.

By selecting the “Pan” button 930, the mouse pointer will appear as an open hand on the map 3000, which allows the user to move the map 3000 in any direction by clicking and dragging the mouse pointer. For instance, to pan right, the user must click and drag the mouse pointer to the left, which will in turn reveal the area of the map 3000 immediately to the right of the map 3000 within the current extension.

By selecting the “Identify” button 940, the mouse pointer will appear with a black circle with an “i” inside to its right, which allows the user to click on a feature on the map 3000 to view the data for this feature in the database.

By selecting the “Select” button 950, the mouse pointer will appear as an arrow, which allows the user to select one or more features contained in the selected layer in the legend 3100 (shown in FIG. 31). To select one or more features, the user must click-and-drag the mouse pointer, which select all those features within the rectangle generated. A selected feature will appear highlighted in a particular color, such as cyan.

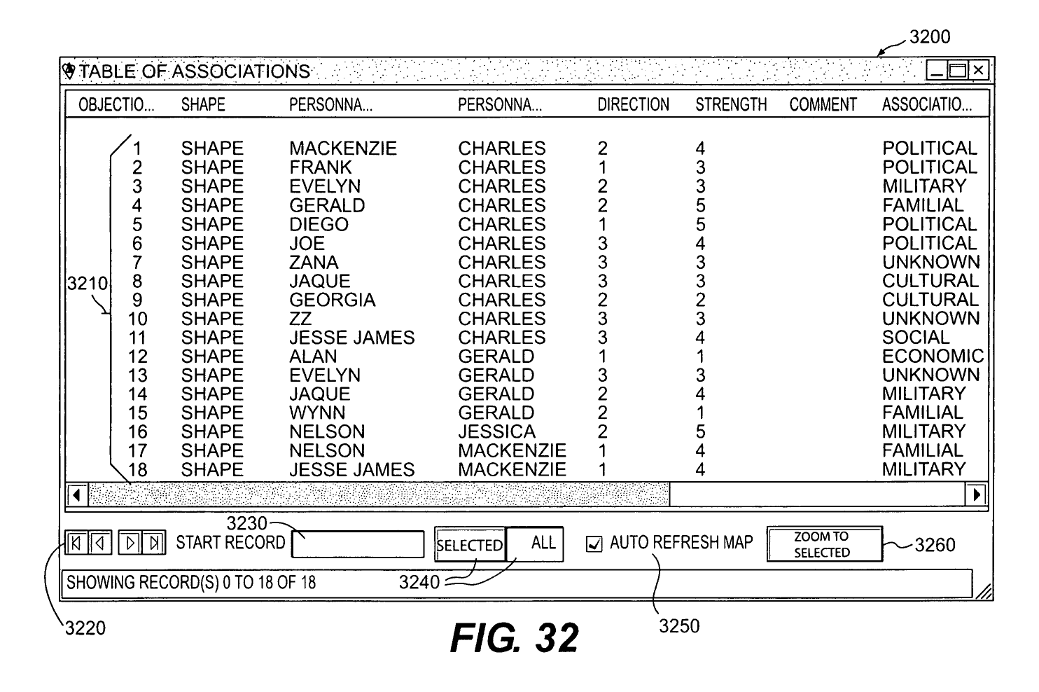

The “User Preferences” interface 1000 shown in FIG. 10 allows the user to select certain settings of the application during the user's session. These settings include the “Unknowns” Location” setting 1010, the “Inflow Directory” setting 1020 and the “View Table Cache” setting 1030. With regard to the “Unknowns' Location” setting 1010, the user is prompted to choose one of three locations on the map 3000 where unknown persons and assets will be plotted. The choices in the corresponding dropdown box may be for example, the Atlantic Ocean (which may be the default location), The Indian Ocean, or the Pacific Ocean. With regard to the “Inflow Directory” setting 1020, the user must set the directory where Inflow 3.0 can be found. This will allow the user to open Inflow 3.0 from the software application of the preferred embodiment and to store the Inflow input files generated using the software application. The user clicks the “Browse” button 1040 associated with the “Inflow Directory” setting 1020, which opens a new window with a directory tree where the user can navigate to the proper folder where Inflow 3.0 is stored. With regard to the “View Table Cache” setting 1030, the user may set the number of records the View Table interface 3200 (shown in FIG. 32) will display at one time using a corresponding “View Table Cache” dropdown box 1050. The user may choose a number provided by the “View Table Cache” dropdown box 1050, or type in the number of records.

Entity and Asset Data Management

The software application of the preferred embodiment employs data for entities, such as persons, for which the user has data.

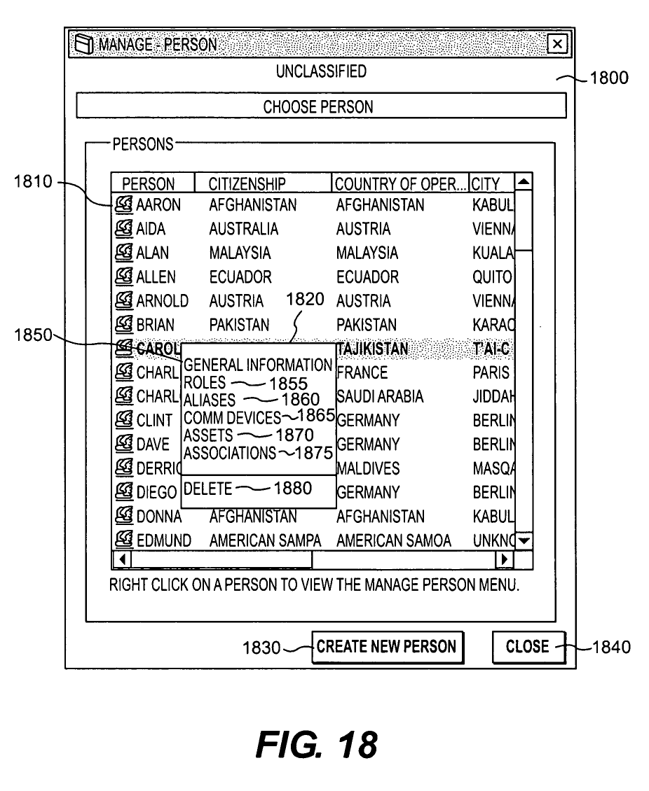

The software application of the preferred embodiment utilizes a “Person” wizard, which allows the user to enter all the attribute and relationship data for a single person. The user can access the “Person” wizard “General Information” interface 1100 by clicking the “Create New Person” button 1830 on the “Choose Person” interface 1800 (shown in FIG. 18), or by double-clicking the “Manage DB” icon 210, and then the “Add a Person” icon 310 in the “Startup” screen 200 of the preferred embodiment.

In accordance with the software application of the preferred embodiment, there are seven steps that are employed to specify information concerning a new person. These steps include receiving general information concerning the person, receiving information about the role(s) associated with that person, receiving information about the aliases assumed by that person, receiving information about the communication devices (optionally) linked to that person, receiving information about the assets linked to that person, receiving information about the associations that the person has with other persons, and providing summary information concerning the person.

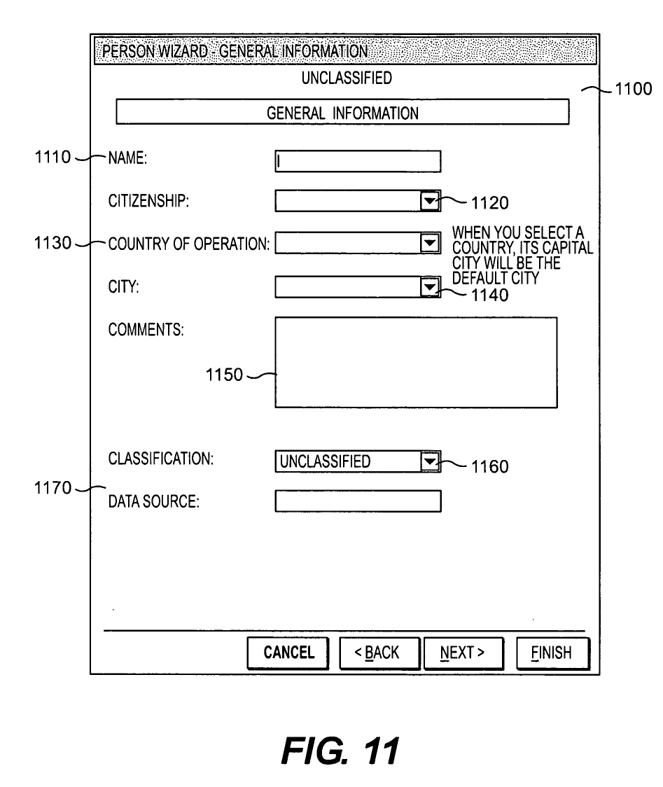

The “Person” wizard begins by receiving the new person's general information in the “General Information” interface 1100, as shown in FIG. 11. This general information includes attribute information about the person including the name, citizenship, country of operation, city, comments, classification, and source of data for the person. A “Name” textbox 1110 is provided for receiving the name of the new person. The user may select one of the countries listed in the Citizenship and Country of Operation dropdown boxes 1120 and 1130, as well as one of the cities listed in the City dropdown box 1140. If any of these attributes is unknown by the user, the user should choose “Unknown” listed in the dropdown box 1120, 1130 and 1140. Once the user has selected the new person's citizenship, the Country of Operation and City dropdown boxes 1130 and 1140 will automatically be populated with that country and the country's capital (if it is in the database), respectively. The user may continue through the wizard until the person's name, country of operation, and city fields have been set. A “Comments” textbox 1150 is provided for receiving comments. A “Classification” dropdown box 1160 is provided for receiving classification information. A “Data Source” textbox 1170 is also provided for providing information concerning the source of the information pertaining to a person.

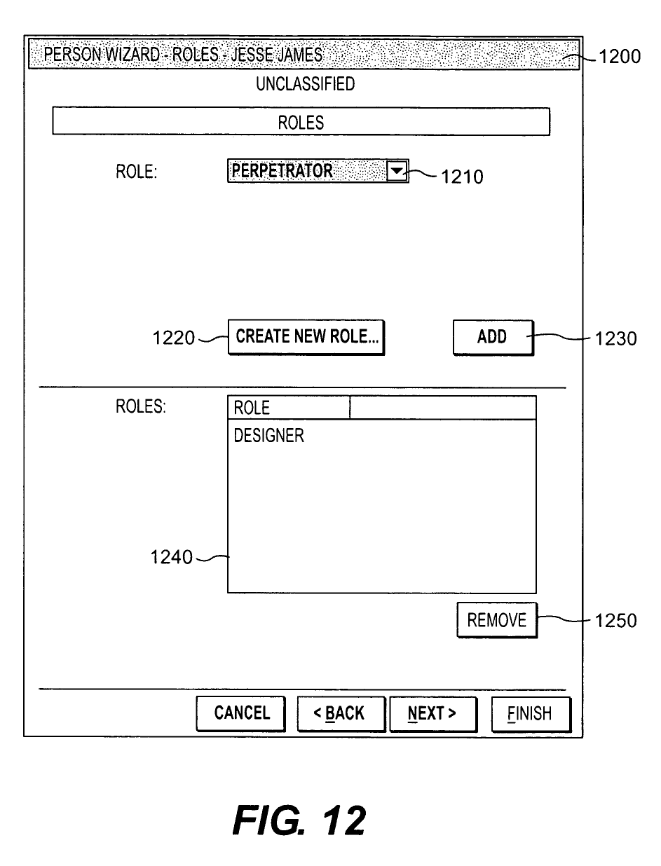

In the next step (the “Roles” step), the “Roles” interface 1200 of the “Person” wizard receives information on the different roles that may be assumed by the person, as shown in FIG. 12. The user can assign the new person one or more roles. A role may be any position, task, or responsibility a person may have generally, or in a particular mission or assignment. The “General Information” interface 1100 of the “Person” Wizard allows a user to specify and review attribute information concerning the role(s) assumed by a person through the use of a “Role” drop down box 1210, a “Create New Role” button 1220, an “Add” button 1230, a “Roles” list 1240 and a “Remove” button 1250.

The user may select a role from the given list in the “Roles” dropdown box 1210. Once selected, the user must click the “Add” button 1230 to place the role in the “Roles” list 1240 at the bottom of the interface. If the user wishes to add a new role to the database, the user must click the “Create New Role” button 1220. The user will then be prompted with an “Add New—Role” option via a dialogue box where the user can type in a new role. Upon clicking “OK,” the new role will be added to the “Roles” dropdown box 1210 and automatically selected for the user to add to the new person's list of roles 1240. A person can have an unlimited number of roles. A role can be removed from the list 1240 by selecting the role and clicking the “Remove” button 1250, or by double-clicking the role in the list 1240.

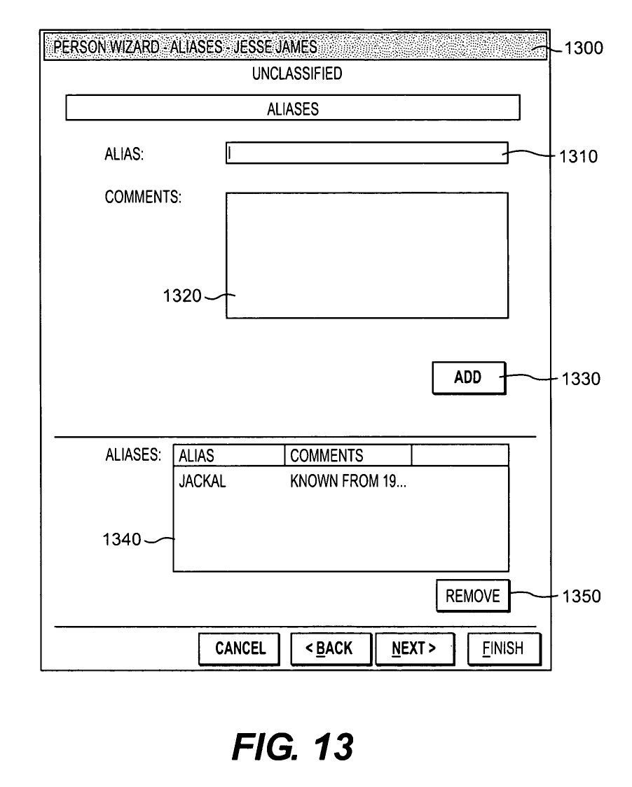

In the next step (the “Aliases” step), the “Aliases” interface 1300 of the “Person” wizard receives attribute information concerning the person's known aliases, as shown in FIG. 13. The “Person” wizard facilitates the receipt of such information through the use of an “Alias” textbox 1310, a “Comments” textbox 1320, an “Add button” 1330, an “Aliases” list 1340, and a “Remove” button 1350.

The user can add aliases for the new person using the “Person” wizard by typing the alias into the “Alias” textbox 1310 provided, and an optional comment up to 250 characters in the “Comments” textbox 1320. Then the user clicks the “Add” button 1330 to add the alias to the “Aliases” list 1340 at the bottom of the interface and the cursor returns to a blank “Alias” textbox 1310, ready for another alias. A user may add an unlimited number of aliases for a single person. The user may remove any alias from the list 1340 by selecting the alias and then clicking the “Remove” button 1350, or by double-clicking the alias in the list 1340.

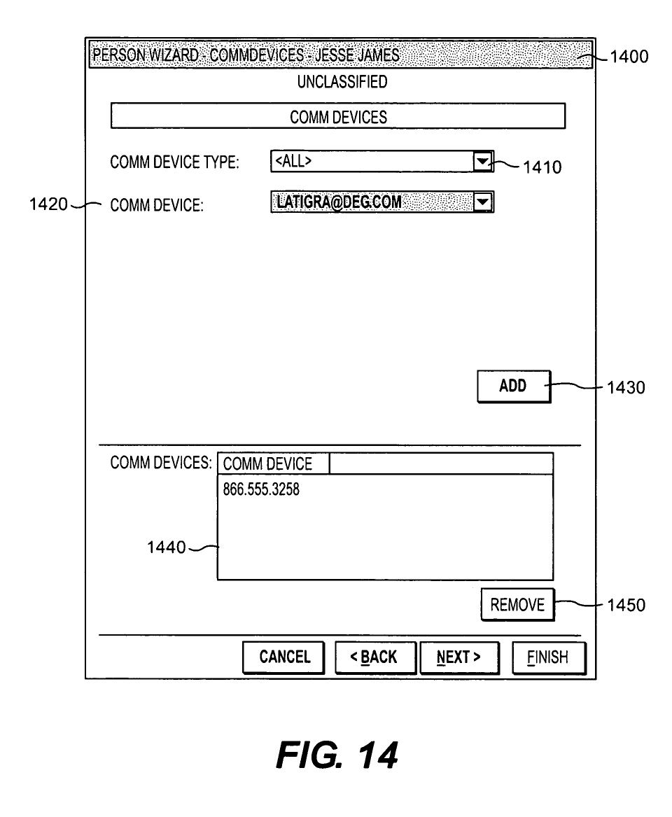

In the next step (the “Comm Device” step), the “Comm Devices” interface 1400 of the “Person” wizard facilitates the linking of the person with one or more communication devices, for which information is stored in the database, as shown in FIG. 14. A communication device (i.e., comm device), which is a type of asset, is a means of communication used to contact the person, or used by the person to contact another, such as a telephone, e-mail address, or fax machine. The “Person” wizard facilitates the receipt of information concerning the linking of the person with communication device(s) via a “Comm Device Type” dropdown box 1410, a “Comm Device” dropdown box 1420, an “Add” button 1430, a “Comm Devices” list 1440, and a “Remove” button 1450.

When the “Comm Device” step is initiated, the user will find every communication device in the database listed in the “Comm Devices” dropdown box 1420. This list 1420 can be filtered to contain only those of a selected communication device type by selecting a type in the “Comm Device Type” dropdown box 1410. Once the user selects a communication device and clicks the “Add” button 1430, that communication device will appear in the “Comm Devices” list 1440 at the bottom of the interface 1400. A person may be linked to an unlimited number of communication devices. The user may remove a communication device from the list by selecting the communication device in the list and clicking the “Remove” button 1450, or by double-clicking the communication device in the list 1440.

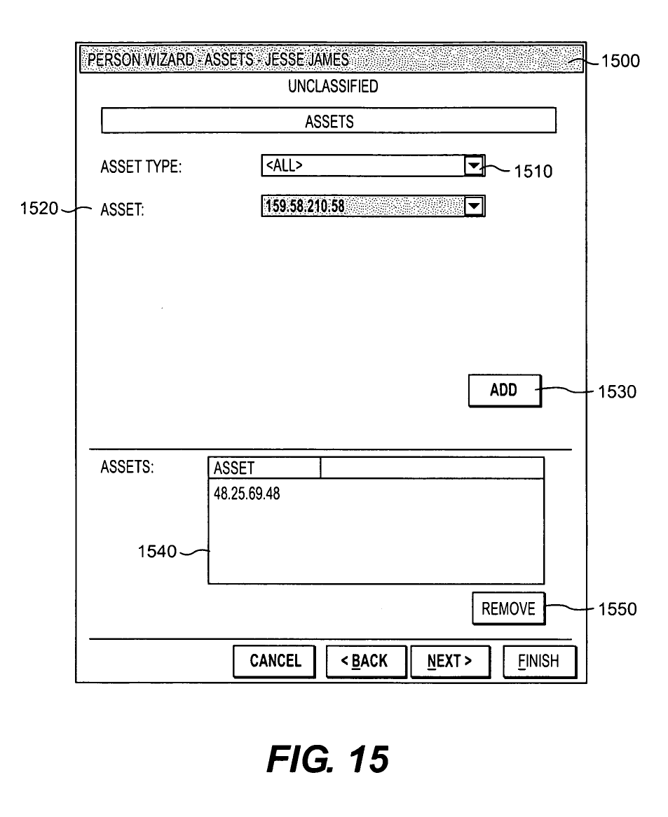

In the next step (the “Assets” step), the “Assets” interface 1500 of the “Person” wizard facilitates the linking of the new person with one or more assets in the database, as shown in FIG. 15. An asset may be tangible or intangible. A tangible asset may be a component of a communication system, like an e-mail server, or a telephone router. The “Person” wizard facilitates the receipt of attribute information concerning the linking of the person with asset(s) via an “Asset Type” dropdown box 1510, an “Asset” dropdown box 1520, an “Add” button 1530, an “Assets” list 1540, and a “Remove” button 1550.

The “Asset” dropdown box 1520 initially lists all the assets in the database. This list 1520 can be filtered to only contain a selected type of asset by selecting a type from the “Asset Type” dropdown box 1510. The user links the person with an asset by selecting that asset from the “Asset” dropdown box 1520 and then clicking the “Add” button 1530, which will place the asset in the “Assets” list 1540. An unlimited number of assets can be linked to a person. To remove an asset from the list 1540, the user must select the asset in the list 1540 and click the “Remove” button 1550, or double-click the asset in the list 1540.

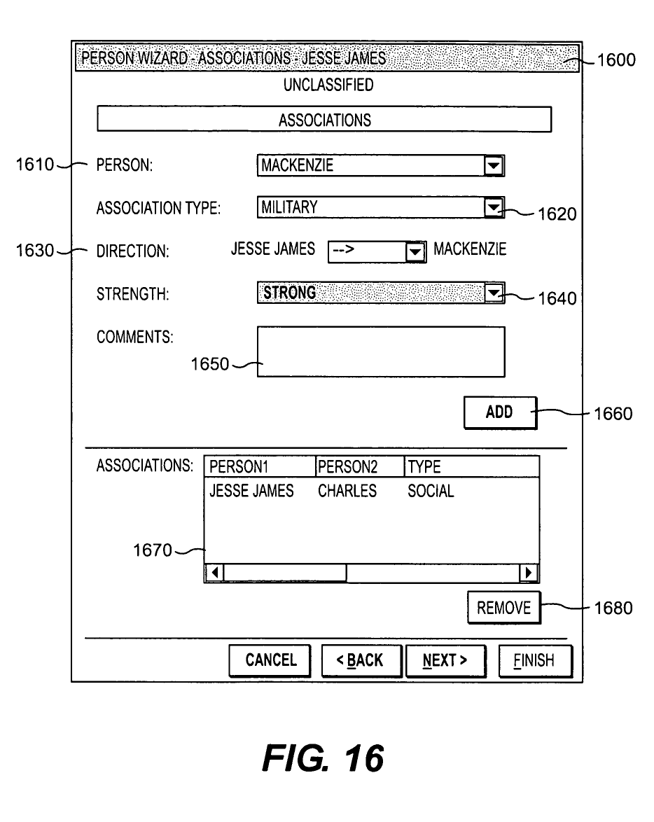

In the next step (the “Associations” step), the “Associations” interface 1600 of the “Person” wizard facilitates the association of a person to one or more other persons that exist in the database, as shown in FIG. 16. The “Person” wizard facilitates the receipt of attribute information concerning an association between persons via a “Person” dropdown box 1610, an “Association Type” dropdown box 1620, a “Direction” dropdown box 1630, a “Strength” dropdown box 1640, a “Comments” textbox 1650, an “Add” button 1660, an “Associations” list 1670, and a “Remove” button 1680.

To begin adding a new association, the user first selects a person from the “Person dropdown box 1610, which lists all the persons in the database. Each association has a type attribute, a direction attribute, a strength attribute, and a comment attribute, which may each have default values. By way of example, the “Association Type” may be set to Unknown, the “Comment” may be left blank, the “Direction” may be set to both directions, and the “Strength” may be set to moderate. If default values are provided, the user may set values for the attributes, which override those default values. To set the association type attribute, the user can select one from the “Association Type” dropdown box 1620, or by typing a new association type in this dropdown box 1620. The direction of the association can be selected using the “Direction” dropdown box 1630, which allows 3 types of directions: (1) From New Person To Selected Associate, (2) From Selected Associate To New Person, and (3) in both of the aforementioned directions.

The user may select the direction that is from the person to the selected associate by choosing the arrow that begins at the new person's name and points at the selected associate's name, which are displayed on either side of the “Direction” dropdown box 1630. The user may also select the direction that is from the selected associate to the person by choosing the arrow that begins at the selected associate's name and points at the new person's name, which are displayed on either side of the “Direction” dropdown box 1630. The user may also select both directions if the new person and selected associate are known to communicate with each other. The user may select both directions by choosing the double-sided arrow from the “Direction” dropdown box 1630.

The strength of an association can be assigned by selecting one of five strength values from the “Strength” dropdown box 1640. These values include “Very Weak”, “Weak”, “Moderate”, “Strong”, and “Very Strong.”

The “Comments” textbox 1650 allows a user to enter any other pertinent information, up to a certain number of characters (e.g., 250 characters).

Once the association attributes have been set, the user clicks the “Add” button 1660 to add the association to the “Associations” list 1670. The “Associations” list 1670 displays the persons' association, type, direction, strength, and comment with respect to each of the added associations. To edit an association, the user must select the association in Associations list 1670. This action will set the association attributes to their respective values and change the “Add” button 1660 to an “Update” button (not shown). Now the user may make any necessary changes. To save these changes, the user must click the “Update” button. To remove an association, the user selects the association in the list and clicks the “Remove” button 1650, or double-clicks the association in the list 1670.

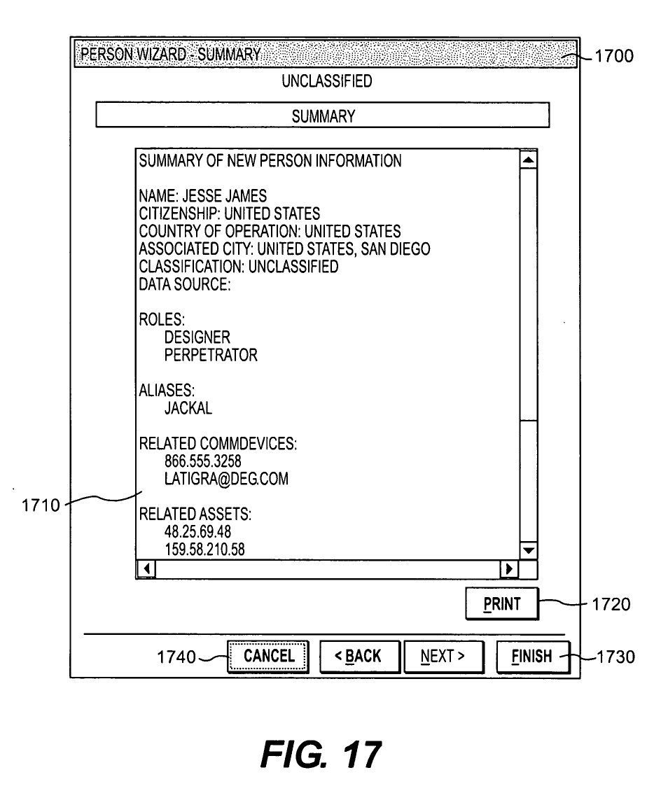

In the next step (the “Summary” step), the “Summary” interface 1700 of the “Person” wizard provides a complete description of the information that the user has selected and/or entered about a new person, as shown in FIG. 17. In particular the user will be provided with the complete description via the “Summary” textbox 1710, and may print out a hard copy of that summary description by clicking on the “Print” button 1720. The software application of the preferred embodiment will send the summary to the computer's default printer or some other networked printer. Upon entering the “Summary” step, the “Finish” button 1730 is enabled. Clicking the “Finish” button 1730 will add the new person's attributes and associations to the database. At any time the user may click the “Cancel” button 1740 to end the “Person” wizard without adding the new person to the database.

At any time while running the software application of the preferred embodiment, a user may edit a person, its attributes and its associations stored in the database. To do so, the user clicks Manage→Person 620 in the menu bar 600 of the software application or clicks the “Manage DB” icon 210, and then the “Manage Persons” icon 320 on the Startup screen 200 to open a “Choose Person” interface. As shown in FIG. 18, the user will find the following items in the “Choose Person” interface 1800: a “Persons” list 1810, a “Manage Person” drop-down menu 1820 (visible when user right-clicks on a person), a “Create New Person” button 1830, and a “Close” button 1840.

The “Choose Person” interface 1800 lists each person stored in the database with the following exemplary data: Name, Citizenship, Country of Operation, City, Comment, Classification, Data Source, Date Created, Date Modified. The Date Created and Date Modified data are time stamp information that may be used to assess information relating to different persons. Using the “Choose Person” interface 1800, the user can access the “Person” wizard by clicking the “Create New Person” button 1830, or the user can edit a person by right-clicking the person. Right-clicking the person opens the “Manage Person” dropdown menu 1820 in which the user can choose options corresponding to the following categories: “General Information” 1850, “Roles” 1855, “Aliases” 1860, “Comm Devices” 1865, “Assets” 1870, and “Associations” 1875. Selecting one of the first six options will open the related interface so as to allow the user to edit that person's data. This interface is identical to corresponding step in the “Person” wizard in which the user may edit the data for the person. The user may also delete the person's data by selecting “Delete” 1880 from the “Manage Person” drop-down menu 1820.

The “General Information” interface (not shown) allows the user to edit the following person attributes: Name, Citizenship, Country of Operation, City, Comments, Classification, and Data Source. The “General Information” interface also displays the date the person was created and last modified, but the user may not edit these fields.

When the “General Information” interface is open, each data field is populated with current data that is stored in the database, which can be edited by the user. The functionality of this interface is the same as that in the corresponding “General Information” step in the “Person” wizard. To save these changes, the user must click the “OK” button, otherwise clicking the “Cancel” button or “X” will result in no changes made to data in the database.

The “Roles” interface (not shown) allows the user to edit or delete the stored roles for the selected person and add new roles. The “Roles” interface populates the “Roles” list with those values associated with the selected person in the database. The functionality of this interface is the same as that in the corresponding “Roles” step in the “Person” wizard. To save these changes, the user must click the “OK” button, otherwise clicking the “Cancel” button or “X” will result in no changes made to data in the database.

The “Aliases” interface (not shown) allows the user to edit or delete the stored aliases for the selected person and add new aliases. The “Aliases” interface populates the “Aliases” list with those values associated with the selected person in the database. The functionality of this interface is the same as that in the corresponding “Aliases” step in the “Person” wizard. To save these changes, the user must click the “OK” button, otherwise clicking the “Cancel” button or “X” will result in no changes made to data in the database.

The “Comm Devices” interface (not shown) allows the user to edit or delete the stored links between the selected person and communication devices in the database and add new links with communication devices to the database. The “Comm Devices” interface populates the “Comm Devices” list with those linked to the selected person in the database. The functionality of this interface is the same as that in the corresponding “Comm Device” step in the “Person” wizard. To save these changes, the user must click the “OK” button, otherwise clicking the “Cancel” button or “X” will result in no changes made to data in the database.

The “Assets” interface (not shown) allows the user to edit or delete the stored links between the selected person and assets and add new links with assets to the database. This interface populates the “Assets” list with those linked to the selected person in the database. The functionality of this interface is the same as that in the corresponding “Assets” step in the “Person” wizard. To save these changes, the user must click the “OK” button, otherwise clicking the “Cancel” button or “X” will result in no changes made to data in the database.

The “Associations” interface (not shown) allows the user to edit or delete the stored associations and add new associations to the database. This interface populates the “Associations” list with people associated with the selected person in the database. The functionality of this interface is the same as that in the corresponding “Associations” step in the “Person” wizard. To save these changes, the user must click the “OK” button, otherwise clicking the “Cancel” button or “X” will result in no changes being made to data in the database.

Upon selecting “Delete” 1880 from the “Manage Persons” dropdown menu 1820, a message box (not shown) will be displayed asking the user confirm that the selected person (and all corresponding data from the database) should be deleted. If the user clicks “Yes,” the selected person and all corresponding data is removed from the database, and the person is removed from the “Persons” list 1810 in the “Choose Person” interface. Clicking “No” will cancel the delete action.

An asset may be tangible or intangible. By way of example, a tangible asset may be a physical component of a communication system, like an e-mail server, or a telephone router. Persons may possess a physical asset or in the case of communications assets may be related to assets via means of communication (e.g., their e-mail server). In addition, communication assets may be related to other such assets through a physical communication infrastructure.

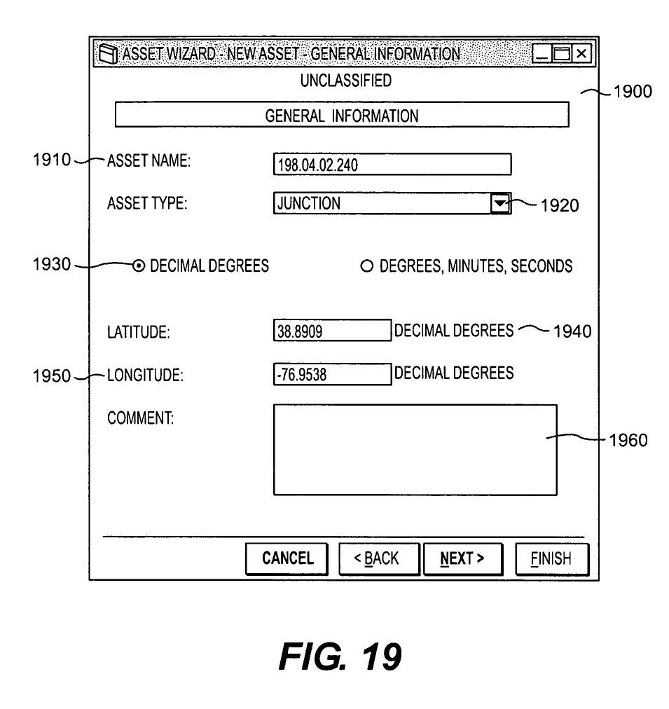

The “Asset” wizard allows the user to enter all the attribute and link data for a single asset. The “Asset” wizard begins by collecting the new asset's general information in the “General Information” step. In this step, the “General Information” interface 1900 of “Asset” wizard provides for collection of the information, as shown in FIG. 19. In particular, the “Asset” wizard may collect the following types of information, Asset Name, Asset Type, Coordinate Units (which may be decimal degrees by default), Latitude, Longitude, and Comments.

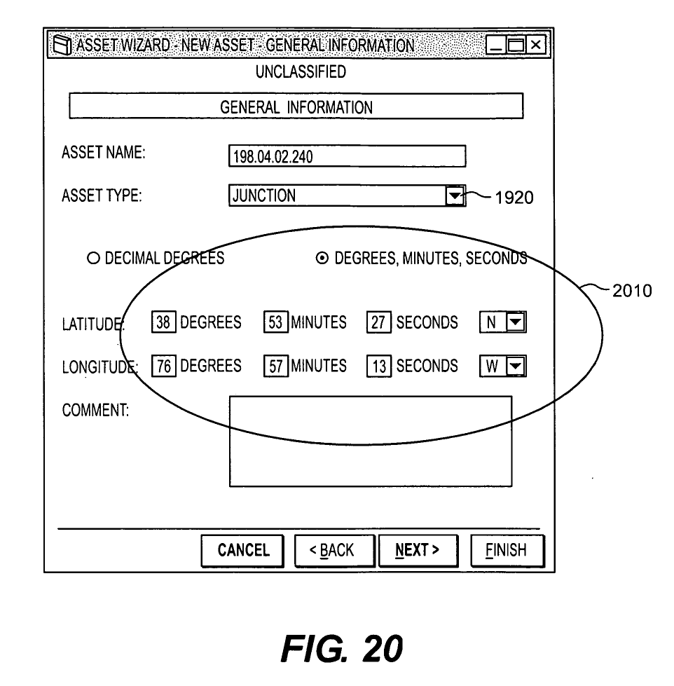

The user specifies an asset name in the “Asset Name” textbox 1910 and selects one of the asset types from the “Asset Type” dropdown box 1920, which lists all available asset types for the software application of the preferred embodiment. If the type is unknown or is not listed, the user should select “Unknown.” The “Asset” wizard may permit entry of Coordinate Units via radio buttons 1930. The default coordinate units are decimal degrees (DD). However, if the user's data is in degrees, minutes, seconds (DMS), the user may click the “Degrees, Minutes, Seconds” button. By choosing DMS, the latitude and longitude textboxes 1940 and 1950 will switch to textboxes 2010 to accept DMS coordinates, as shown in FIG. 20.

The user should note that DMS coordinates do not accept a minus (−) prefix. To indicate a particular direction, the user should use the direction dropdown boxes (“N” is positive and “S” is negative for latitude, and “E” is positive and “W” is negative for longitude). If the user enters the coordinates in DMS and then clicks the DD option, the coordinates will be converted to DD and appear in the DD textboxes, and vice versa. The user may not continue through the “Asset” wizard until the asset's name and type fields have been set. The “Comment” textbox 1960 allows a user to enter in comments concerning a new asset.

In the next step (the “Asset Links” step), the “Asset” wizard facilitates the linking of the new asset with one or more assets in the database. The “Asset” dropdown box initially lists all the assets in the database. This list can be filtered to only list a selected asset type by selecting an asset type from the “Asset Type” dropdown box. The user links the new asset with another asset by selecting the other asset from the “Asset” dropdown box and then clicking the “Add” button, which will place the asset in the “Assets” list. An unlimited number of assets can be linked to the new asset. To remove an asset from the list, the user must select the asset in the list and click the “Remove” button, or double-click the asset in the list.

In the next step (the “Person Links” step), the “Asset” wizard facilitates the linking of the new asset with one or more persons in the database. The “Person” dropdown box initially lists all the persons in the database. This list can be filtered to only list those persons from a particular country by selecting that country from the “Country” dropdown box. The user links the new asset with a person by selecting the person from the “Person” dropdown box and then clicking the “Add” button, which will place the person in the “Persons” list. An unlimited number of persons can be linked to an asset. To remove a person from the list, the user must select the person in the list and click the “Remove” button, or double-click the person in the list.

In the next step (the “Summary” step), the “Asset” wizard provides a complete description of what the user has selected and entered about the new asset. The user may print a hard copy of the summary by clicking the “Print” button, and the software application of the preferred embodiment will send the summary to the computer's default printer or another printer. Upon entering this step, the “Finish” button is enabled. Clicking the “Finish” button will add the new asset, its attributes, and associations to the database. At any time the user may click “Cancel” to end the wizard without adding the new asset to the database.

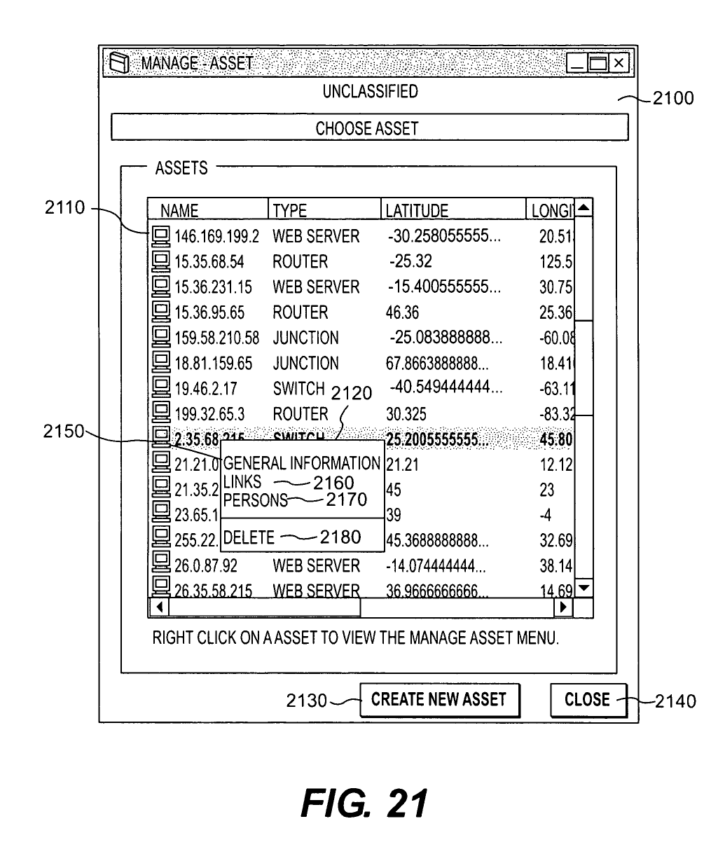

At any time, a user may edit an asset, its attributes and its links within the database. The user clicks the Manage→Assets 620 in the menu bar 600 or clicks the “Manage DB” icon 210, and then the “Manage Assets” icon 340 on the “Startup” screen 200 to open the “Choose Asset” interface 2100. From here, the user can begin the user's edit asset session. As shown in FIG. 21, the user will find the following items in the “Choose Asset” interface 2100: an “Assets” list 2110, a “Manage Asset” dropdown menu 2120 (visible when user right-clicks on a person), a “Create New Asset” button 2130, and a “Close” button 2140.

The “Choose Asset” interface 2100 lists each asset stored in the database, along with the following data stored with the asset: Name, Type, Latitude, Longitude, and Comment (not shown).

In the “Choose Asset” interface 2100, the user can access the “Asset” wizard by clicking the “Create New Asset” button 2130, or the user can edit an asset by right-clicking the asset in the “Assets” list 2110. Right-clicking the asset opens the “Manage Asset” dropdown menu 2120 where the user can choose one of the following options to edit that asset's data: General Information 2150, Links 2160, Persons 2170, and Delete 2180.

Selecting one of these options will open a related interface, which is identical to corresponding step in the “Asset” wizard, in which the user may edit the data.

Selecting the “General Information” option 2150 calls the “General Information” interface that allows the user to edit the following asset attributes: “Name”, “Asset Type”, “Latitude”, “Longitude”, and “Comments”. At open, each data field is populated with the current data stored in the database and can be edited by the user. The functionality of this interface is the same as that in the corresponding “General Information” step of the “Asset” wizard. The user should note that the coordinate units will appear as the user last saved them. Thus, if the coordinates were last saved in decimal degrees (DD), the DD option will be selected, and the latitude and longitude textboxes will be in DD form. If the coordinates were saved in degrees, minutes, seconds (DMS), the DMS option will be selected, and the latitude and longitude textboxes will be in the DMS form. To save these changes, the user must click the “OK” button, otherwise clicking the “Cancel” button or “X” will result in no changes made to data in the database.

Selecting the “Links” option 2160 calls the “Links” interface that allows the user to edit or delete the stored links with other assets and add new links to the database. This interface populates the “Link Assets” list with those assets linked to the selected asset in the database. The functionality of this interface is the same as that in the corresponding “Asset Links” step in the “Asset” wizard. To save these changes, the user must click the “OK” button, otherwise clicking the “Cancel” button or “X” will result in no changes made to data in the database.

Selecting the “Persons” option 2170 calls the “Persons” interface that allows the user to edit or delete the stored links with persons and add new links to the database. This interface populates the “Persons” list with those persons linked to the selected asset in the database. The functionality of this interface is the same as that in the corresponding “Person Links” step in the “Asset” wizard. To save these changes, the user must click the “OK” button, otherwise clicking the “Cancel” button or “X” will result in no changes made to data in the database.

Selecting the “Delete” option 2180 from the “Manage Assets” dropdown menu, the user will be prompted with a message box that confirms that the user wants to delete the selected asset and all corresponding data from the database. If the user clicks “Yes”, the selected asset and all corresponding data is removed from the database, and the asset is removed from the asset list in the “Choose Asset” interface. Clicking “No” will cancel the delete action.

A communication device, which may be referred to as a comm device, is a physical component of a communication system, such as a telephone, cell phone, an e-mail server, or a telephone router through which any means of communication travels among persons. A communication device is linked to a person through its use to contact a person or its use by a person.

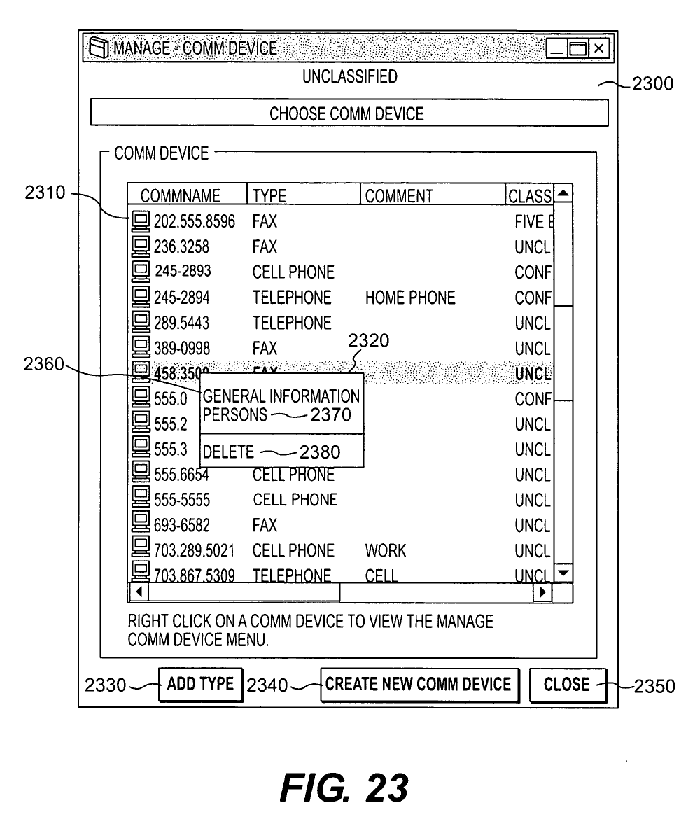

The “Comm Device” wizard provides the user an intuitive series of steps to add a new communication device and its data to the database. The user can access the “Comm Device” wizard by clicking the “Create New Comm Device” button 2340 (shown in FIG. 23) on the “Choose Comm Device” interface or by clicking the “Manage DB” icon 210 and then the “Add a Comm Device” icon 350 in the Startup screen 200.

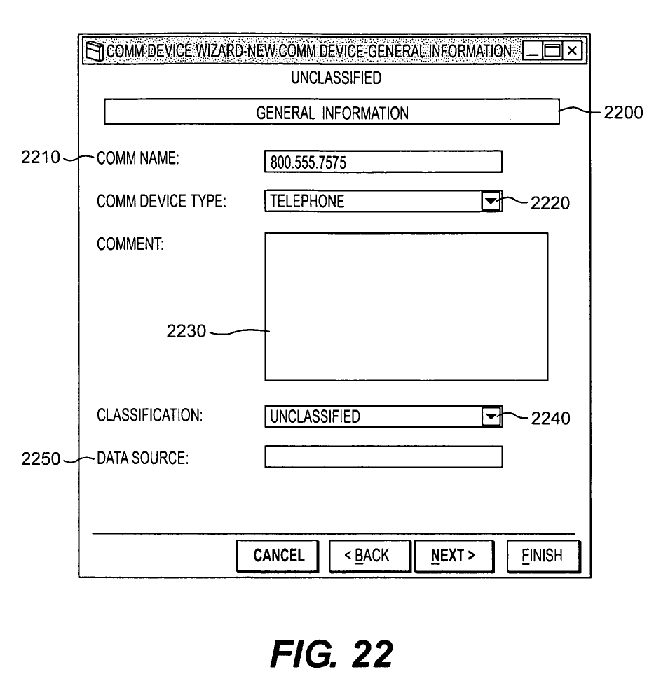

In the first step (the “General Information” step), the “General Information” interface 2200 of the “Comm Device” wizard begins by collecting the new comm device's general information, as shown in FIG. 22. This information includes attribute information collected via a “Comm Name” textbox 2210, “Comm Device Type” dropdown box 2220, “Comments” textbox 2230, “Classification” dropdown box 2240, and “Data Source” textbox 2250.

The user must select one of the comm device types from the “Comm Device Type” dropdown box 2220, which lists all available comm device types for the software application of the preferred embodiment. If the type is unknown or is not listed, the user should select “Unknown.” The user cannot continue through the wizard until the comm name and type fields have been set.

In the next step (the “Persons” step), the “Comm Device” wizard facilitates the linking of the new communication device with one or more persons in the database. The “Person” dropdown box initially lists all the persons in the database. This list can be filtered to only list those persons from a particular country by selecting that country from the Country dropdown box. The user links the new communication device with a person by selecting the person from the “Person” dropdown box and then clicking the “Add” button, which will place the person in the “Persons” list. An unlimited number of persons can be linked to a communication device. To remove a person from the list, the user must select the person in the list and click the “Remove” button, or double-click the person in the list.

In the next step (the “Summary” step), the “New Comm Device” wizard provides a complete description of what the user has selected and entered about the new communication device. The user may print a hard copy of the summary by clicking the “Print” button, and the software application of the preferred embodiment will send the summary to the computer's default printer or another printer. Upon entering this step, the “Finish” button is enabled. Clicking the “Finish” button will add the new communication device, its attributes, and associations to the database. At any time the user may click “Cancel” to end the wizard without adding the new communication device to the database.

At any time, a user may edit information relating to a communication device, including its attributes and its associations within the database. The user clicks the Manage→Comm Devices 620 in the software application's Menubar 600 or clicks the “Manage DB” icon 210, and then the “Manage Comm Devices” icon 360 on the Startup screen 200 to open the “Choose Comm Device” interface. From there, the user can begin the user's edit communication device session. As shown in FIG. 23, the user will find the following items in the “Choose Comm Device” interface 2300: a “Comm Device” list 2310, a “Manage Comm Device” dropdown menu 2320 (visible when user right-clicks on a person), an “Add Type” button 2330, a “Create New Comm Device” button 2340, and a “Close” button 2350.

The “Choose Comm Device” interface 2300 lists each communication device stored in the database, along with the following attribute data stored with the communication device: “Comm Name”, “Comm Device Type”, “Comment”, “Classification”, “Data Source” (not shown), “Date Created”(not shown), and “Date Modified” (not shown).

Using the “Choose Comm Device” interface 2300, the user can access the “Comm Device” wizard by clicking the “Create New Comm Device” button 2340, or the user can edit information relating to a communication device by right-clicking on the communication device in the “Comm Device” list 2310. Right-clicking on the communication device opens the “Manage Comm Device” dropdown menu 2320 where the user can choose to edit that communication device's data via the following options: “General Information” 2360 and “Persons” 2370. In addition, a user may delete information relating to a communication device by choosing the “Delete” option 2380 from the “Manage Comm Device” drop down menu 2320.

Selecting one of these will open the related interface, which is identical to corresponding step in the “Comm Device” wizard, in which the user may edit the data.

Selecting the “General Information” option 2360 will call the “General Information” interface that will display the following communication device attributes: “Name”, “Comm Device Type”, “Comments”, “Classification”, “Data Source”, “Date Created” (read only), and “Date Modified” (read only). When the (Edit Comm Device) “General Information” interface is opened, each data field is populated with the current data stored in the database and can be edited by the user, except “Date Created” and “Date Modified”, which are read only. The functionality of the “General Information” interface is the same as that in the corresponding “General Information” step of the “Comm Device” wizard. To save changes, the user must click the “OK” button, otherwise clicking the “Cancel” button or “X” will result in no changes made to data in the database.

Selecting the “Persons” option 2370 will call the (Edit Comm Device) “Persons” interface that will allow the user to edit or delete the stored links with persons and add new links to the database. This interface populates the “Persons” list with those persons linked to the selected communication device in the database. The functionality of this interface is the same as that in the corresponding “Persons” step of the “Comm Device” wizard. To save these changes, the user must click the “OK” button, otherwise clicking the “Cancel” button or “X” will result in no changes made to data in the database.

By Selecting the “Delete” option 2380 from the “Manage Comm Devices” dropdown menu 2320, the user will be prompted with a message box (not shown) confirming that the user wants to delete the selected communication device and all corresponding data from the database. If the user clicks “Yes”, the selected communication device and all corresponding data will be removed from the database, and the communication device is removed from the “Comm device” list 2310 in the “Choose Comm Device” interface. Clicking on “No” will cancel the delete action.

The “Import” dropdown menu 630 shown in FIG. 6 allows the user to import information through two methods: “Import Records” and “Import Database”. The user should note that the database used in each method must have the same schema, tables, and field names as the database to work properly. If the software application of the preferred embodiment comes across a record with a city that is not in the database, a message box will let the user know the city name and then permit the user to continue.

Choosing “Import Records” option from the “Import” dropdown menu 630, the user is prompted with a directory tree from which the user can find and select the database that holds the records the user would like to import. The user must then highlight the desired database and click the “Open” button, or double-click the database. However, this database must have the same schema, tables, and field names as the database to work properly. Once the database has been chosen, the application will open the “Import Data” wizard, through which the user can select individual records he/she would like to import into the database.

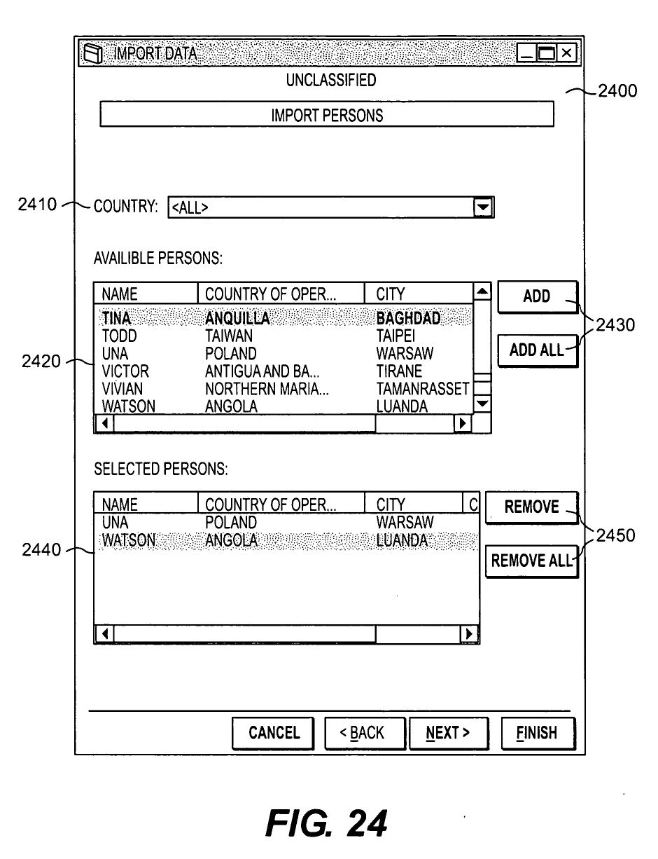

In the first step (the “Import Persons” step), the user chooses the person(s) the user would like to import into the database (employed with the software application of the preferred embodiment) from the selected database, as shown in FIG. 24.

In the “Import Persons” step, the user will see the following items of the “Import Persons” interface 2400: a “Country” dropdown box 2410, an “Available Persons” list 2420, “Add/Add All” buttons 2430, a “Selected Persons” list 2440, and “Remove/Remove All” buttons 2450.

The “Country” dropdown box 2410 lists all the countries of operation for persons in the selected database. Choosing a country in the dropdown box will filter the “Available Persons” list 2420 so as to only display those persons with the chosen country of operation.

The “Available Persons” list 2420 initially shows all persons stored in the selected database. The “Country” dropdown box 2410 can be used to filter the list by country of operation. One or many persons may be selected at one time by using the “Shift” or “Ctrl” keys in conjunction with the mouse. Double-clicking a person in the “Available Persons” list 2420 will add that person to the “Selected Persons” list 2440.

Use of the “Add” button 2430 will populate the “Selected Persons” list 2440 with all those persons selected in the “Available Persons” list 2420. Use of the “Add All” button 2430 will populate the “Selected Persons” list 2440 with all the persons currently in the “Available Persons” list 2420.

The “Selected Persons” list 2440 displays all those persons selected from the “Available Persons” list 2420 by the user to be included in the import. Double-clicking a person in the “Selected Persons” list 2440 will remove that person from the list.

Use of the “Remove” button 2450 will remove just those persons selected, while use of the “Remove All” button 2450 will clear the entire “Selected Persons” list 2440.

In the next step (the “Import Assets” step), the user will choose assets the user would like to import into the database (used with the software application of the preferred embodiment) from the selected database. In the “Import Assets” step, the user will see the following items in a setup very similar to that shown in FIG. 24: an “Asset Type” drop down box (not shown), an “Available Assets” list (not shown), “Add/Add All” buttons (not shown), “Selected Assets” list (not shown), and “Remove/Remove All” buttons (not shown).

The “Asset Type” dropdown box lists all the asset types in the selected database. Choosing an asset type in the dropdown box will filter the “Available Assets” list to only display those assets of the selected asset type.

The “Available Assets” list initially shows all assets stored in the selected database. It can be filtered by asset type by using the “Asset Type” dropdown box to filter the list. One or many assets may be selected at one time by using the “Shift” or “Ctrl” keys in conjunction with a mouse. Double-clicking an asset in this list will add that asset to the “Selected Assets” list.

Use of the “Add” button will populate the “Selected Assets” list with all those assets selected in the “Available Assets” list. Use of the “Add All” button will populate the “Selected Assets” list with all the assets currently in the “Available Assets” list.

The “Selected Assets” list displays all those assets selected from the “Available Assets” list by the user to be included in the import from the selected database. Double-clicking an asset in this list will remove that asset from the list.

The use of the “Remove” button will remove just those assets selected from the “Selected Assets” list. The use of the “Remove All” button will clear the entire “Selected Assets” list.

In the next step (the “Import Comm Devices” step), the user chooses communication devices that the user would like to import into the database from the selected database. In the “Import Comm Devices” step, the user will see the following items in a setup identical to that which is shown in FIG. 24: a “Comm Devices Type” dropdown box, an “Available Comm Devices” list, “Add/Add All” buttons, a “Selected Comm Devices” list, and “Remove/Remove All” buttons.

The “Comm Device Type” dropdown box lists all the communication device types in the selected database. Choosing a communication device type in the “Comm Device Type” dropdown box will filter the “Available Comm Devices” list to only display those communication devices of the selected communication device type.

The “Available Comm Devices” list initially shows all communication devices stored in the selected database. It can be filtered by communication device type by using the “Comm Device Type” dropdown box to filter the list. One or many communication devices may be selected at one time by using the “Shift” or “Ctrl” keys in conjunction with a mouse. Double-clicking a communication device in the “Available Comm Devices” list will add that communication device to the “Selected Comm Devices” list.

The use of the “Add” button will populate the “Selected Comm Devices” list with all those communication devices selected in the “Available Comm Devices” list. The use of the “Add All” button will populate it with all the communication devices currently in the “Available Comm Devices” list.

The “Selected Comm Devices” list displays all of those communication devices selected from the “Available Comm Devices” list by the user to be included in the import. Double-clicking a communication device in this list will remove that communication device from the list.

Use of the “Remove” button will remove just those communication devices selected from the “Selected Comm Devices” list. Use of the “Remove All” button will clear the entire “Selected Comm Devices” list.

In the next step (the “Import Summary”) step, a summary of the records to be imported will be displayed, including those corresponding to persons, assets and communication devices in the “Selected Persons” list, the “Selected Assets” list, and the “Selected Comm Devices” list.

The user can print this summary by pressing the “Print” button. Upon entering the Summary step, the “Finish” button is enabled. Upon clicking the “Finish” button, the selected records will be imported into the database. When the import is complete, a message box will appear letting the user know the import was successful.

Choosing “Import Database” option from the “Import” dropdown menu 630, the user is prompted with a directory tree from which the user can find and select the database that the user would like to import. This function imports the entire database to the database employed with the software application of the preferred embodiment, as long as there are no duplicate records already in the database. The database to be selected should have the same schema, tables, and field names as the database used with the software application of the present invention in order to work properly.

Project Management

In the software application of the preferred embodiment, projects serve as the basis for mapping data relating to entities and assets (including communication devices). The software application of the preferred embodiment determines what features to map based on the data that is stored for a project.

The “New Project” wizard allows the user to create a project by selecting those persons and assets that the user would like to see plotted on a map. The software application of the preferred embodiment also maps the first-degree associations of those persons or assets directly associated with or linked to each other that are stored in the project. The information related to a project is stored in the database.

The “New Project” wizard can be accessed through two methods. One method involves clicking the “Project” icon 220 in the “Startup” screen 200, and then clicking the “New Project” icon 410 when it appears. The second method involves clicking the “Create New Project” button 2940 in the “Choose Project” interface 2900 of FIG. 29 discussed below.

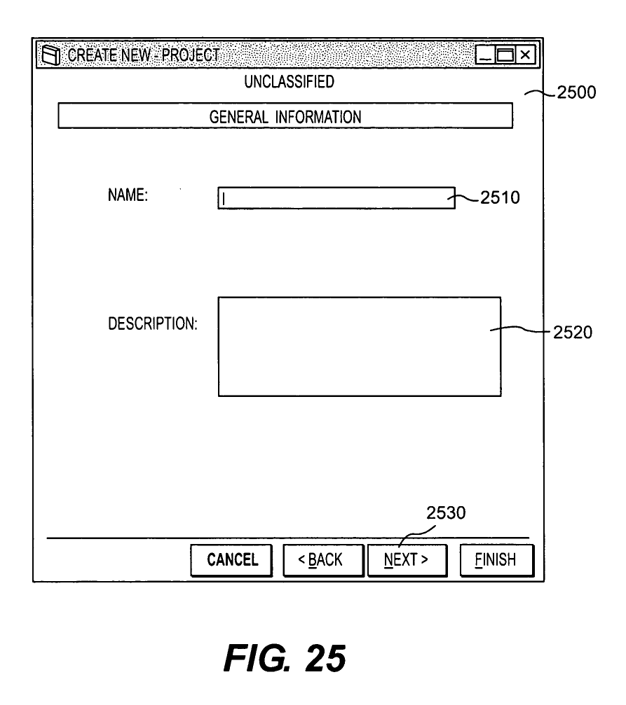

Upon starting the “New Project” wizard, the user will, as part of the “General Information” step, find the following items, which are part of the “General Information” interface 2500 shown in FIG. 25: a “Name” textbox 2510 and a “Description” textbox 2520. The user will be immediately prompted by the “New Project” wizard to enter a unique name for the project. The user may also add a description of the project. Once the user has entered a project name, the user may click the “Next” button 2530 to proceed to the next step in the wizard. However, if a project with the same name already exists within the database, the software application of the preferred embodiment will alert the user and prompt the user for a new project name.

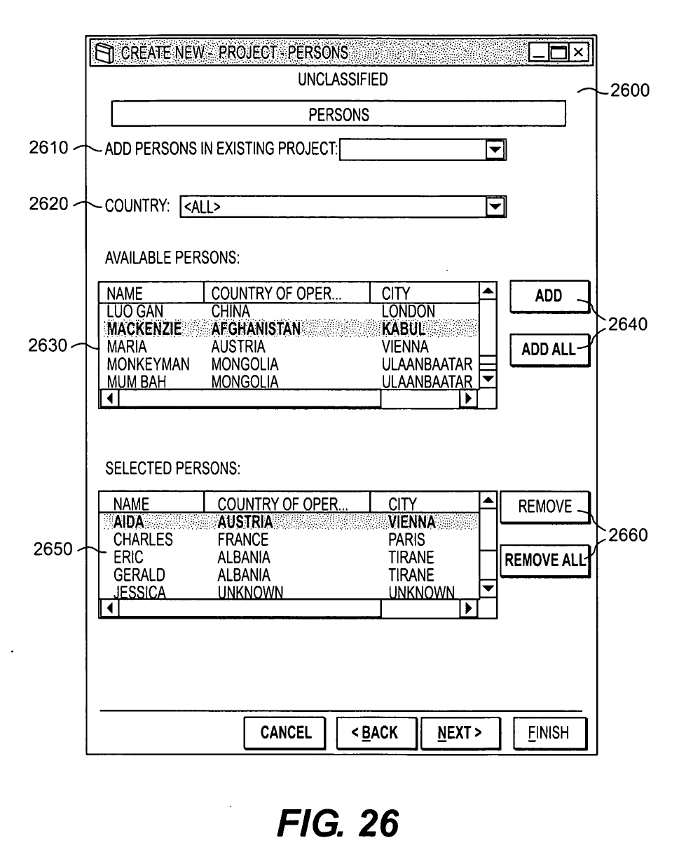

In the next step (the “Persons” step), the user will choose persons from the database that the user would like to include as part of the new project. In the Add Persons step, the user will see the following items, which are part of the “Persons” interface 2600 shown in FIG. 26: an “Add Persons in Existing Project” drop down box 2610, a “Country” dropdown box 2620, an “Available Persons” list 2630, “Add/Add All” buttons 2640, a “Selected Persons” list 2650, and “Remove/Remove All” buttons 2660.

The “Add Persons in Existing Project” dropdown box 2610 lists all the projects stored in the database and allows the user to quickly select all those persons in a specific project to add to the new project. Clicking on a project name in the dropdown box 2610 will add those persons to the “Selected Persons” list 2650.

The “Country” dropdown box 2620 lists all the countries of operation for persons in the database. Choosing a country in the “Country” dropdown box 2620 will filter the “Available Persons” list 2630 so that only those persons with the chosen country of operation are displayed.

The “Available Persons” list 2630 initially shows all persons stored in the database. The “Available Persons” list 2630 can be filtered by country of operation by using the “Country” dropdown box 2620 to filter the list 2630. One or many persons may be selected from the list 2630 at one time by using the “Shift” or “Ctrl” keys in conjunction with the mouse. Double-clicking a person in this list 2630 will add that person to the Selected Person list 2650.

The use of the “Add” button 2640 will populate the “Selected Persons” list with all those persons selected, while the use of the “Add All” button 2640 will populate it with all the persons currently in the “Available Persons” list 2630.

The “Selected Persons” list 2650 displays all those persons selected from the “Available Persons” list 2630 that the user would like to be included in the new project. Double-clicking a person in the “Selected Persons” list 2650 will remove that person from the list 2650.

Use of the “Remove” button 2660 will remove just those persons selected, while use of the “Remove All” button 2660 will clear the entire “Selected Persons” list 2650.

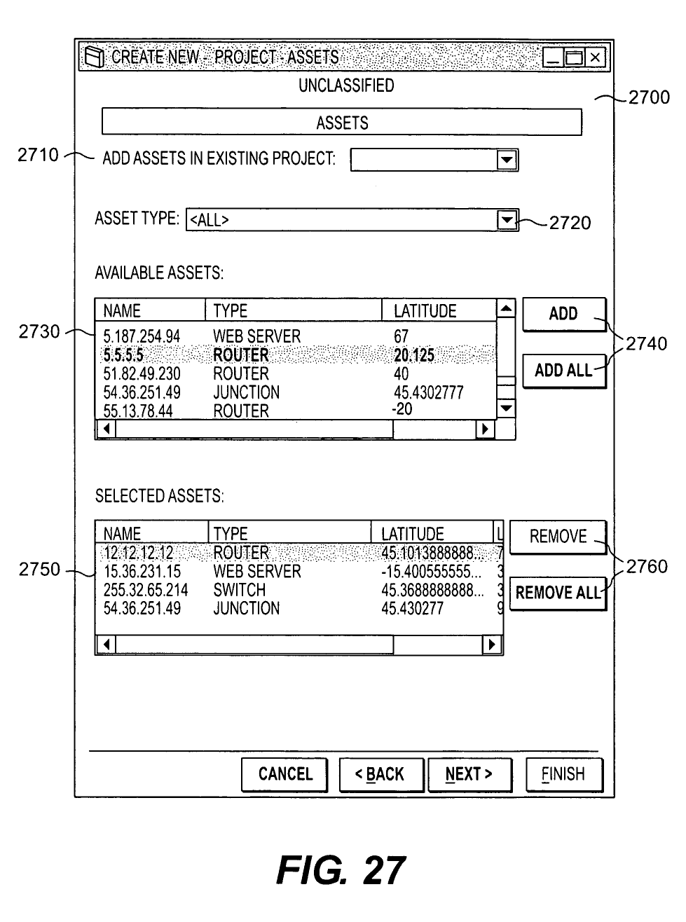

In the next step (the “Assets” step), the user selects assets from the database for inclusion in the new project. In the “Assets” step, the user will see the following items, which are shown as part of the “Assets” interface 2700 in FIG. 27: an “Add Assets in Existing Project” dropdown box 2710, an “Asset Type” dropdown box 2720, an “Available Assets” list 2730, “Add/Add All” buttons 2740, a “Selected Assets” list 2750, and “Remove/Remove All” buttons 2760.

The “Add Assets in Existing Project” dropdown box 2710 lists all the projects stored in the database and allows the user to quickly select all those assets in a specific project to add to the new project. Clicking a project name will add those assets to the “Selected Assets” list 2750.

The “Asset Type” dropdown box 2720 lists all the asset types in the database. Choosing an asset type in the “Asset Type” dropdown box 2720 will filter the. “Available Assets” list 2730 to only display those assets of the selected asset type.

The “Available Assets” list 2730 initially shows all assets stored in the database. It can be filtered by asset type by using the “Asset Type” dropdown box 2720 to filter the list 2730. One or many assets may be selected at one time by using the “Shift” or “Ctrl” keys in conjunction with the mouse. Double-clicking an asset in this list will add that asset to the “Selected Assets” list 2750.

The use of the “Add” button 2740 will populate the “Selected Assets” list 2750 with all those assets selected, while the use of the “Add All” button 2740 will populate the “Selected Assets” list 2750 with all the assets currently in the “Available Assets” list 2730.

The “Selected Assets” list 2750 displays all those assets selected from the “Available Assets” list 2730 by the user to be included in the new project. Double-clicking an asset in this list 2750 will remove that asset from the list 2750.

The use of the “Remove” button 2760 will remove from the “Selected Assets” list 2750 just those assets selected, while the use of the “Remove All” button 2760 will clear the entire “Selected Assets” list 2750.

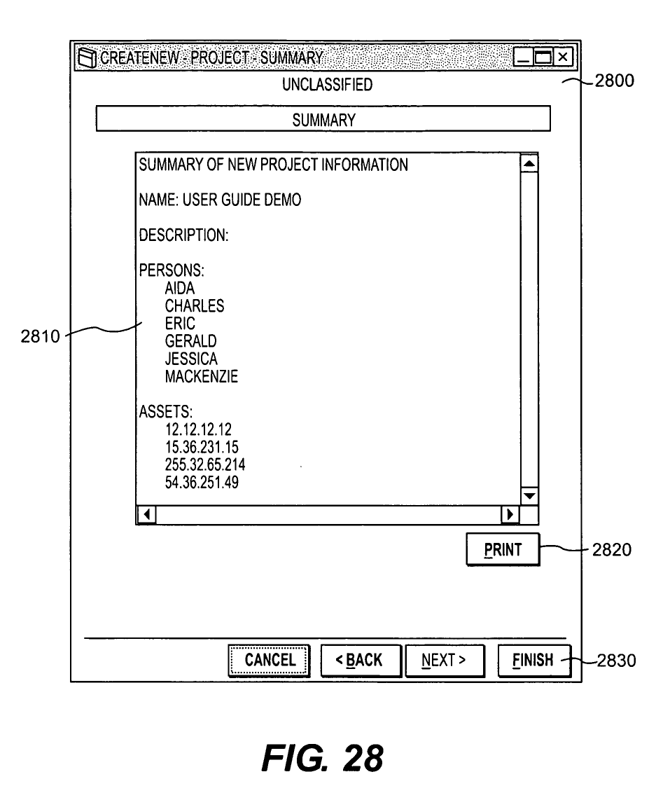

In the next step (the “Summary” step), the “New Project” wizard, as shown in FIG. 28, displays the following items as part of the “Summary” interface 2800: a “Summary” textbox 2810 and a “Print” button 2820.

Within the “Summary” text box 2810 is displayed summary information relating to the new project, including: the project name, description, selected persons and selected assets. The user can print this summary information by pressing the “Print” button 2820. Upon entering the “Summary” step, the “Finish” button 2830 is enabled. Clicking the “Finish” button 2830, the new project will be added to the database, and a dialogue box (not shown) will appear letting the user know of the successful project creation and ask the user if the user would like to map the project. Clicking the “Yes” button will add the project to the map. Clicking the “No” button will just close the dialogue box.

At any time, a user may edit a project, its attributes and its associations within the database, add the project to the map, or copy the project under a new name. The user clicks the Manage→Projects 620 in the main menu bar 600 of the software application of the preferred embodiment or clicks the “Projects” icon 220, and then the “Manage Projects” icon 420 on the “Startup” screen 200 to open the “Choose Project” interface. Thereafter, the user can begin to manage the projects.

The user will find the following items in the “Choose Project” interface 2900 that is shown in FIG. 29: a “Projects” list 2910, a “Manage Project” dropdown menu 2920 (visible when user right-clicks on a person), an “Add Project to Map” button 2930, a “Create New Project” button 2940, and a “Close” button 2950.

The “Choose Project” interface 2900 lists each project stored in the database, along with the following data stored with the project: “Name”, “Description”, “Date Created”, and “Date Modified”.

In the “Choose Project” interface 2900, the user can access the “New Project” wizard by clicking the “Create New Project” button 2940. Right clicking on a project shown in the “Projects” list 2910 opens the “Manage Project” dropdown menu 2920 where the user can manipulate the project by selecting one of the following options: “Add Project to Map” 2960, “Save As” 2965, “General Information” 2970, “Persons” 2975, “Assets” 2980, and “Delete” 2985.

In accordance with the “Add Project to Map” option 2960, the user can add a project to the map using three different methods. The user may select a project and click the “Add Project to Map” button 2930 in the lower left-hand corner of the “Choose Project” interface, or the user can right-click a project and choose the “Add Project to Map” option 2960 from the “Manage Project” dropdown menu 2920, or the user may double-click a project in the “Projects” list 2910.

In accordance with the “Save As” option 2965, the user can make a copy of any project. After right clicking a project and choosing the “Save As” option 2965 from the “Manage Project” dropdown menu 2920, a dialogue box (not shown) will appear prompting the user to name the copy of the selected project. The “Name” textbox (not shown) will initially display the name of the project the user would like to copy. However, the software application of the preferred embodiment will not allow the copy to have the same name as the project or any other project within the database. The user must click “OK” to save the copy, or “Cancel” to cancel the action.

After right clicking a project in the “Projects” list 2910 and choosing the “General Information” option 2970 from the “Manage Project” dropdown menu 2920, the “General Information” interface will allow the user to rename the selected project and edit the project's description. The user must click “OK” in order to save the changes made to the project. However, the software application of the preferred embodiment will not allow the user to rename the project with the same name as any other project in the database.

After right clicking a project in the “Projects” list 2910 and choosing the “Persons” option 2975 from the “Manage Project” dropdown menu 2920, the “Persons” interface is called. This interface allows the user to manage the persons affiliated with the selected project. Initially, the “Selected Persons” list is populated with those persons in the selected project. The functionality of this interface is the same as that in the corresponding “Persons” step of the “New Project” wizard. Therefore, the user may add or remove any person to or from the project in the same fashion as when creating it. To save these changes, the user must click the “OK” button, otherwise clicking the “Cancel” button or “X” will result in no changes made to data in the database.

After right clicking a project and choosing the “Assets” option 2980 from the “Manage Project” dropdown menu 2920, an “Assets” interface will be called. This interface allows the user to manage the assets affiliated with the selected project. Initially, the “Selected Assets” list is populated with those assets in the selected project. The functionality of this interface is the same as that in the corresponding “Assets” step of the “New Project” wizard. Therefore, the user may add or remove any asset to or from the project in the same fashion as when creating it. To save these changes, the user must click the “OK” button, otherwise clicking the “Cancel” button or “X” will result in no changes made to the data in the database.

Selecting the “Delete” option 2985 from the “Manage Project” dropdown menu 2920, the user will be prompted with a message box (not shown) asking the user to confirm that the selected project is to be deleted along with all corresponding data from the database. If the user clicks the “Yes” button, the selected project will be removed from both the database and the “Projects” list 2910 in the “Choose Project” interface 2900. Clicking on the “No” button will cancel the delete action.

Mapping Projects

The software application of the preferred embodiment maps the projects created by user(s) as a data visualization aid using a Geographic Information System (GIS). A user can map a project using four different approaches. The first approach involves use of the “New Project” wizard to create a project. Thereafter, the user will be asked to confirm whether the user would like to view the project on the map. Clicking on the “Yes” icon will map the project. In the second approach, the user selects a project in the “Projects” list 2910 and then clicks on the “Add Project to Map” button 2930. In response, the project will be mapped. In the third approach, the user right clicks a project in the “Projects” list 2910 and then chooses the “Add Project to Map” option 2960. In response, the project will be mapped. In the fourth approach, the user double-clicks on the project in the “Projects” list 2910. In response, the project will be mapped.

All mapped projects appear in the map control window 3000 of FIG. 30 located on the right of the application window on the display. The user may manipulate the map using the map functions and tools located in the toolbars of the software application of the preferred embodiment.

As shown in FIG. 30, the map displays the following features: persons 3010, associations 3020, assets 3030, asset links 3040, person-asset links 3050, and countries 3060.

The persons in a project are plotted in their respective cities as points color-coded according to their respective country of operation. This color code is random and is different for each project added to the map. If more than one person in a project is located in the same city, a bold red number will appear above and right of this point indicating the number of persons in that city.

The person-to-person associations 3020 are plotted as, for example, blue lines connecting the points of the two persons involved. The thickness of the lines corresponds to the strength of the association, and the arrowheads on the line indicate the direction of the association.

The project assets 3030 are plotted at their respected coordinates as orange, for example, diamonds. If more than one asset in a project is located at the same coordinate, a bold orange number will appear above and left of this point indicating the number of assets at that point.

The asset-to-asset links 3040 are plotted as, for example, orange lines connecting the points of the assets involved.

The person-to-asset links 3050 are plotted as, for example, black lines connecting the point of the person and asset involved.

The map displays the countries 3060 of the world in a color, for example, pale yellow, that will not contrast with the projects mapped.

The user may view any information stored with these features in the database by using the available functions and tools in the toolbars employed with the software application of the preferred embodiment.

The map legend 3100 appears to the left of the map control window 3000 in the software application window of the preferred embodiment. As is apparent from FIG. 31, the map legend 3100 helps the user determine the symbols for the following: “Project Grouplayer” 3110, “Project People Layer” 3120, “Project Associations Layer” 3130, “Project Assets Layer” 3140, “Project Asset Links Layer” 3150, “Project Persons-Assets Layer” 3160, and “Countries Layer” 3170.

To select a layer for manipulation or querying, the user clicks the layer name in the legend 3100. Each mapped project consists of a grouplayer 3110 (same name as the project), which is made up of five layers for the persons, associations, assets, asset links, and person/asset links generated from the data in project. To view the symbol for each of these layers, the user can either click the plus sign ([+]) next to the layer name, or double-click the layer name. Clicking the checkbox next to each layer will make the layer invisible until the user clicks the checkbox again. The user can change the color of the person-to-person associations by right-clicking on the “Project Associations Layer” 3130 in the legend, and choosing “Change Color”. A color palette will appear for the user to choose a new color for the lines. The user can rearrange the order of the layers on the map by clicking and dragging a layer up or down the legend, dropping it where the user would like the layer to be drawn.

The user can view the data held by a layer by selecting the layer in the legend 3100, and then clicking the “View Table” button 740 in the “Map Functions” toolbar 700. This will open the “View Table” interface 3200, shown in FIG. 32 where the user can see each record stored in the selected layer. As shown in FIG. 32, the “View Table” interface 3200 or “Table of Associations” consists of the following items: a data table 3210, navigation bar 3220, a “Start Record” textbox 3230, “Selected/All” toggle buttons 3240, an “Auto Refresh Map” checkbox 3250, and a “Zoom to Selected” button 3260.

The data table 3210 displays the records in the selected layer's data table.

The navigation bar 3220 allows the user to navigate through the data table when the table has more records than the “View Table Cache” 1030, which is set in “User Preferences” interface 1000.

The “Start Record” textbox 3230 allows the user to jump directly to a particular record. The user types in the index of the record of interest and presses “Enter” and the table will jump to that record.

The “Selected/All” toggle buttons 3240 switch the table from displaying all the records to only those selected on the map in the table 3210.

If the “Auto Refresh Map” checkbox 3250 is checked, the map will automatically refresh when the user selects any records in the table. The refreshed map will highlight the corresponding features.

The “Zoom to Selected” button 3260 allows the user to zoom the map to an extent that includes all of the features corresponding to the selected records in the data table.

The user can sort the visible records by any field by clicking on the column name in the table 3210. If any features on that layer are selected on the map, the corresponding records in the table will be highlighted. If the user selects any records in the table, the corresponding features will be selected on the map. The user can view only the records for those selected features by clicking the “Selected” button 3240 at the bottom of the “View Table” interface, and can return to view all the records by clicking “All”. As long as a feature is selected on the map, the user can zoom in on the selected feature(s) on the map by clicking the “Zoom to Selected” button on the “View Table” interface 3200.

Exporting Information for External Software Applications

The software application of the preferred embodiment will generate input files in “Comma Separated Value” (.csv) format for use in social network analysis tools, such as Inflow 3.0. From the software application's “Startup” screen 200, the user must double-click the “Social Network” icon 230, then double-click the “Create Inflow Input Files” icon 510 to navigate to the interface. Or the user may click File→Generate Inflow Input files from the “File” dropdown menu 610 in the main menu bar 600.

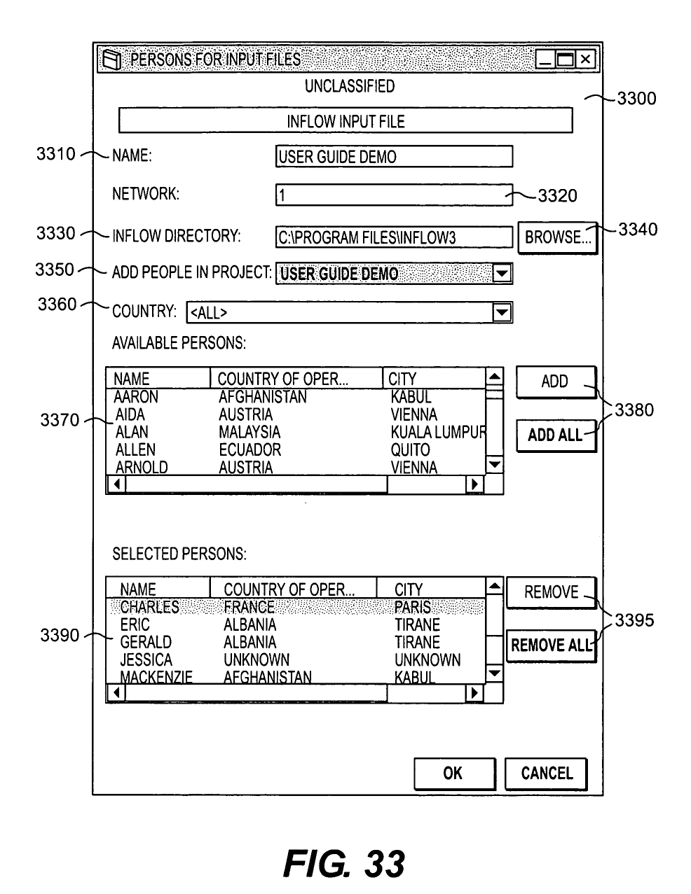

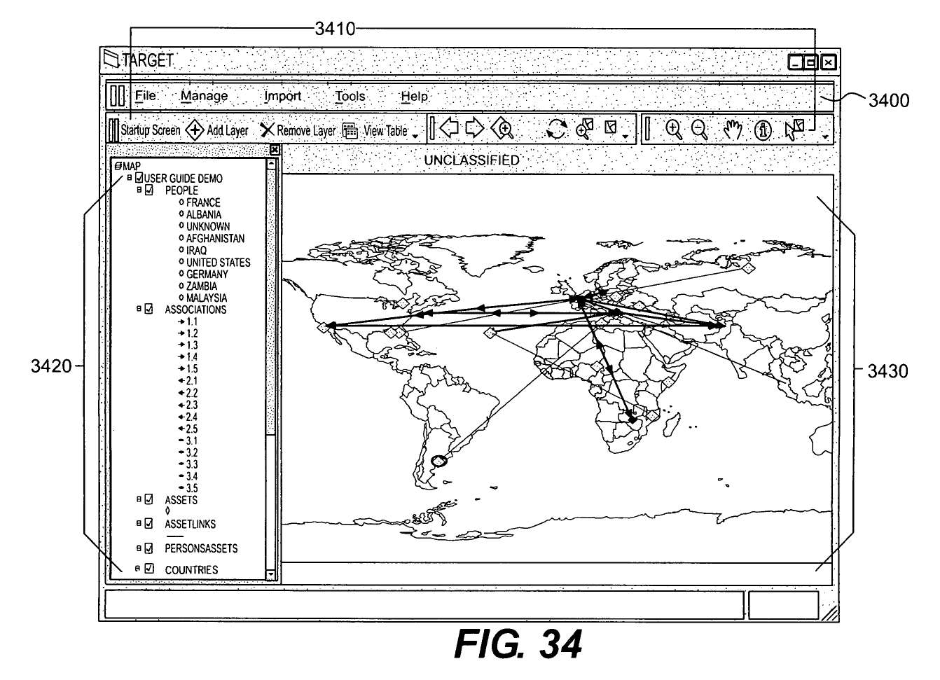

As shown in FIG. 33, the “Inflow Input File” interface 3300 contains the following items: a “Name” textbox 3310, a “Network” textbox 3320, an “Inflow Directory” textbox 3330, a “Browse” button 3340, an “Add People in Project” dropdown box 3350, a “Country” dropdown box 3360, an “Available Persons” list 3370, “Add/Add All” buttons 3380, a “Selected Persons” list 3390, and “Remove/Remove All” buttons 3395.

The “Name” textbox 3310 is where the user enters a name to prefix the nodes and links input files. The “Network” textbox 3320 is where the user enters a network number between 1 and 16 which is used to properly run Inflow 3.0. The “Inflow Directory” textbox 3330 shows the Inflow directory set in the “User Preferences” interface. The “Browse” button 3340 opens a directory tree that allows the user to set the Inflow directory in case the user did not do so in “User Preferences” interface 1000.

The “Add People in Project” dropdown box 3350 lists all the projects stored in the database and allows the user to add those persons in the selected project to the “Selected Persons” list 3390.

The “Country” dropdown box 3360 lists all the countries of operation for persons in the database. Choosing a country in the dropdown box will filter the “Available Persons” list 3370 so that those persons with the chosen country of operation are displayed.

The “Available Persons” list 3370 initially shows all persons stored in the database. It can be filtered by country of operation by using the “Country” dropdown box 3360 to filter the list. One or many persons may be selected at one time by using the “Shift” or “Ctrl” keys in conjunction with the mouse. Double-clicking a person in this list will add that person to the “Selected Person” list 3390.

The use of the “Add” button 3380 will populate the “Selected Persons” list 3390 with all those persons selected in the “Available Persons” list 3370, while the use of the “Add All” button 3380 will populate it with all the persons currently in the “Available Persons” list 3370.

The “Selected Persons” list 3390 displays all those persons selected from the “Available Persons” list 3370 by the user to be included in the new input files. Double-clicking a person in this list 3390 will remove that person from the list 3390.

The use of the “Remove” button 3395 will remove just those persons selected, while the use of the “Remove All” button 3395 will clear the entire “Selected Persons” list 3390.

The user must first enter a name to prefix the nodes and links files generated. Then the user is required to enter a number between 1 and 16 as a network number because Inflow can contain 16 different networks. Next, the user must choose persons from the database that the user would like to include in the input files.

Once the “Selected Persons” list 3390 is populated with all those persons that the user would like to include in the Inflow input files, the user must click “OK” to create the input files. These input files will be stored in the “Input files” folder in the Inflow 3.0 directory, which can be set in the “User Preferences” interface 1000. Two input files are generated, one with node data, and the other with link data. The files will be saved as <input file name>_Nodes.csv and <input file name>_Links.csv. Clicking “Cancel” will result in now input file generation.

Use of Social Network Analysis Metrics

Rather than simply exporting information to social network analysis software such as Inflow 3.0, the preferred embodiment of the present invention may incorporate a social network analysis capability that incorporates metrics that are well-known in the art. These metrics may be employed to measure network centralization, in which the influence of each person (or asset) at a node within the network is assessed. It provides insight into the location of persons (or assets) within a network and the structure of the network.

Network Centrality may be measured using the following metrics that are generally well-known in the art: Degrees, Betweenness, Closeness and Power. “Degrees” is a measure of network activity for a node. An algorithm that may be used to calculate the “Degrees” metric may be found, for example, in the node.cls module provided in the Computer Program Listing submitted herewith. “Betweenness” is a measure of control or influence over what flows into the network. Betweenness may be used to determine the “brokers” or “bottlenecks” within a system. An algorithm that may be used to calculate the “Betweenness” metric may be found, for example, in the nodes.cls module provided in the Computer Program Listing submitted herewith. “Closeness” is a measure of how quickly a node can access all other nodes in the network. An algorithm that that may be used to calculate the “Closeness” metric may be found in the node.cls module provided in the Computer Program Listing submitted herewith. “Power” is a measure of a node's access and control. In particular, “Power” is a function of betweenness and closeness to identify persons (or assets) having quick access while standing in the way of other persons' (or assets) access. An algorithm that may be used to calculate the “Power” metric may be found, for example, in the node.cls module provided in the Computer Program Listing submitted herewith. Although the calculations for the above-mentioned metrics have been incorporated in multiple modules, those skilled in the art will appreciate that those modules may be incorporated into a single module.

Examples of the Use of the Preferred Embodiment

The software patent application of the preferred embodiment is designed to make the task of adding data to the database as simple and intuitive as possible, without losing valuable information and integrity. Following is an example of how a user would add information relating to a person using the New Person wizard to a database (e.g., database 110). A similar procedure involving the New Asset wizard or the Comm Device wizard would be used to add information relating to an asset or a communication device.

Once the software application of the preferred embodiment is running and a classification has been chosen in the manner described above, the user may double-click on the “Manage DB” icon 210 within the Startup screen 200. Thereafter, the user will double click on the “Add a Person” icon 310, which will open the “Add Person” wizard.

The “Person” wizard begins by collecting general information on a new person. First, enter the person's name into the “Name” textbox 1110 of the “General Information” interface 1100. Next, the user would choose the person's citizenship by clicking on the “Citizenship” dropdown box 1120. A country is selected from the list by clicking on it with a mouse. The software application of the preferred embodiment would choose the same country for the “Country of Operation” value and it's capital for the “City” value. If the either of these values is incorrect, the correct country of operation and/or city may be selected from the “Country of Operation” dropdown box 1130 and/or the “City” drop down box 1140. The “City” value is what is what the software application of the preferred embodiment will use as the location for the person when plotted on the map. Also, software application of the preferred embodiment will not allow you to continue to the next step in the wizard until the Name, Citizenship, Country of Operation, and City fields have been entered. An alternative, embodiment may not require all three fields to be specified.

If the citizenship, country of operation, or city is unknown, the user may choose ‘Unknown’ from the corresponding dropdown box 1120, 1130 and 1140. In the “Comment” textbox 1150, the user may enter free text up to 250 characters. However, any number of characters may be allotted for the “Comment” textbox 1150. The “Classification” dropdown box 1160 is automatically populated with the classification selected on the “Startup” screen 200, but it may be changed for a particular person by choosing another classification from the “Classification” drop down box 1160 or by typing in a classification. Thereafter, the data source of the information is entered into the Data Source textbox 1170. Once all relevant data has been entered, click the “Next” button to move to the next step in the “Person” wizard.

Next, the user will be prompted to select one or more roles that the new person is known to perform using the “Roles” interface 1200. To select a role, the user will employ the “Role” dropdown box 1210, and select a role from the list. Once the user has chosen a role, the user should click the “Add” button 1230 and the selected role will be appear in the “Roles” list 1240 at the bottom of the “Roles” interface 1200. If the role the user would like to enter does not appear in the “Role” dropdown box, click the “Create New Role” button 1220 and a dialogue box will appear prompting the user to type in a new role in the textbox provided. Enter the new role and click “OK”. The new role will be added to the database, the “Role” dropdown box 1210, and the “Roles” list 1240. Once the user has selected all the roles for the new person, click the “Next” button to move to the next step in the “Person” wizard.

The user will then enter the known aliases for the new person using the “Aliases” interface 1300. In particular, the user will type an alias into the “Alias” textbox 1310, and then click the “Add” button 1330 to add it to the “Aliases” list 1340 at the bottom of the “Aliases” interface 1300. These steps will be repeated until all of the aliases have been added to the list. Once the user has entered all the aliases for the new person, click the “Next” button to move to the next step in the wizard.

Next, the user will select all of the communication devices used by the new person. In particular, the user will click on the “Comm Device” dropdown box 1410 in the “Comm Device” interface 1400 and select a related communication device from the list provided. Then the user will click on the “Add” button 1430 to add the communication device to the “Comm Devices” list 1440 at the bottom of the “Comm Devices” interface 1400. If a communication device that the user is looking for is not listed in the “Comm Device” dropdown box 1440, then no record for that communication device exists in the database. The user will need to wait until the user has completed the “Person” wizard before adding this communication device using the “Comm Device” wizard, in which a user can relate the communication device and the new person. Once the user has selected all of the new person's communication devices, click the “Next” button to move to the next step in the wizard.

Next, the user will select all the assets used by the new person using the “Assets” interface 1500. In particular, the user will click on the “Asset” dropdown box 1520 and select a related asset from the list. Then, the user will click the “Add” button 1530 to add the asset to the “Assets” list 1540 at the bottom of the “Assets” interface 1500. If an asset the user is looking for is not listed under the “Asset” dropdown box 1520, then no record for that asset exists in the database. The user will need to wait until the user has completed the “Person” wizard before adding this asset using the “Asset” wizard, where the user can relate the asset and the new person. Once the user has selected all of the new person's assets, the user clicks the “Next” button to move to the next step in the “Person” wizard.

Next, the user will establish all of the associations that the new person has with other persons already in the database using the “Associations” interface 1600. To accomplish this, the user selects an associate from the “Person” dropdown box 1610. This will enable the remaining textboxes and dropdown boxes on the “Associations” interface 1600. In the “Association Type” dropdown box 1620, the user selects the appropriate association type for this relationship from the list provided. Alternatively, the user may enter a specific type via a keyboard. Next, the user will select the direction of the relationship. The name of the new person will appear to the left of the “Direction” dropdown box 1630, and the associate's name will appear to the right of the dropdown box. The direction is “both” by default. To change this value, the user clicks on the “Direction” dropdown box 1630 and choose the more appropriate direction from the list. Thereafter, the user will need to set the strength of the association. The “Strength” dropdown box 1640 defaults to ‘Moderate.’ To change this value, the user will click on the “Strength” dropdown box 1640 and choose the appropriate strength from the list. Thereafter, the user may enter free text up to 250 characters in the “Comments” textbox 1650. Once the user has set all the proper values for the current association, the user will click the “Add” button 1660. The values for the association will appear in the “Associations” list 1670 at the bottom of the “Associations” interface 1600, and the textboxes and dropdown boxes at the top will reset, so that the user may enter the next association. If the user would like to make changes to an association already added to the “Associations” list 1670, the user will click on the association in the list 1670. The textboxes and dropdown boxes will be populated with their respective values. The user can then make the necessary changes and then click the “Update” button to update the association in the “Associations” list 1670. Once the user has finished setting all of the associations, the user will click the “Next” button to move to the next step in the “Person” wizard.

The final step in the “Person” wizard displays a summary of the data the user has entered for the new person via the “Summary” interface 1700. The user may review the summary and return to a particular step by clicking the “Back” button until the user has reached that step to make any changes. Once the user is satisfied with the new person, the user will click the “Finish” button. The software application of the preferred embodiment will then add the new person to the database and a message box will appear indicating that the new person has been successfully added to the database.

As indicated above, the GIS is an intuitive component of the software application of the preferred embodiment. The GIS not only enables the user to visualize the data on a map, but it also enables the user to query the database by interacting with the map itself.

Following is an example of how a user would create, map, and manipulate a project through the use of a wizard, interfaces, and the GIS.

Once the software application of the preferred embodiment is running and a classification has been chosen, the user double-clicks the “Projects” icon 220 on the “Startup” screen 200. Next, the user double-clicks the “New Project” icon 410 that appears in the Startup screen 200, which will open the “Create New Project” wizard.

Upon starting the “Create New Project” wizard, the user will enter a name for the new project in the “Name” textbox 2510 of the “General Information” interface 2500. The “Description” textbox 2520 is initially free text, but the user may enter any information about the project the user deems necessary up to 250 characters. Once the user has entered a project name and description, the user clicks the “Next” button to move to the next step in the wizard.

Next, the user will be prompted to select persons from the database that the user would like to add to the new project using the “Persons” interface 2600. The “Available Persons” list 2630 identifies all those persons currently in the database, as well as their corresponding country of operation, city, and comments. To add a person to the project, the user clicks the person's name in the “Available Persons” list 2630 (the person's row will be highlighted) and then clicks the “Add” button 2640. The selected person will appear in the “Selected Persons” list 2650 at the bottom of the “Persons” interface 2600. These steps are repeated until the user has chosen all the persons that the user would like to include in the project. The GIS will map not only the selected persons, but also each selected person's associates and related assets. Once the user has selected all the persons for the new project, the user will click the “Next” button to move to the next step in the wizard.

Next, the user will be prompted to select assets from the database that they would like to add to the new project via the “Assets” interface 2700. The “Available Assets” list 2730 identifies all those assets currently in the database, as well as their corresponding type, latitude, longitude, and comments. To add an asset to the project, the user clicks the asset's name in the “Available Assets” list 2730 (the asset's row will be highlighted), and then clicks the “Add” button 2740. The selected asset will appear in the “Selected Assets” list 2750 at the bottom of the “Assets” interface 2700. These steps are repeated until all the assets to be included within the project have been chosen. Note that the GIS will map not only the selected assets, but also each selected asset's related persons and assets. Once the user has selected all the assets for the new project, the user clicks the “Next” button to move to the next step in the wizard.

Next, the “Create New Project” wizard displays a summary of the data that has been entered for the new project via the “Summary” interface 2800. The user should review this summary and, if necessary, return to any steps to make needed changes by clicking the “Back” button until the user reached those steps. Once the user is satisfied with the new project, the user will click the “Finish” button 2800. The software application of the preferred embodiment will then create the new project in the database. A dialogue box will appear to indicate that the new project was successfully created and to ask the user if the user would like to map the project. The user will click “Yes” to add the new project to the map.

Once complete, the software application's main window 3400 will be divided into three sections, as shown in FIG. 34. These sections include a menus and toolbars section 3410, a legend section 3420 and a map section 3430.

The user will see several colored items on the map 3430, including, for example, orange diamonds and several lines of varying length, width, color, and direction (if any). The Legend 3420 on the left side of the window 3400 allows the user to decipher what each symbol represents. Under the name of the new project, double-click “People” in the Legend 3420. Under “People” the user will now see several colored points next to Country names. This means that persons have been plotted as points color-coded by country of operation. Then if the user double-click “Assets”, the user should now see an orange diamond, which represents an asset on the map. Then if the user double-clicks “Associations”, the user will see below within the Legend 3420 several lines of varying width and direction beside a set of two numbers. The first number represents the direction of an association, which is represented by the direction of the arrows on the corresponding line. The second number is the strength of an association, which is represented by the width of the corresponding line. Looking at the map on the right, the user should see several similar lines across the map. These lines represent actual associations of the persons in the project with varying direction and strength. Then if the user double-clicks “AssetLinks”, an orange line, for example, should appear below it within the Legend 3420 that represents the relationship between two assets on the map. Then if the user double-clicks on “PersonsAssets”, a black line, for example, should appear below within the Legend 3420, which represents a person-asset relationship on the map.

If the user wishes to query the map for some data, the user will click the Information tool located in the Map Tools toolbar in the menus and tool bars section 3410 at the top of the main window 3400. Having clicked on the Information tool, the user can move the mouse pointer over the map. The pointer should appear as an arrow with an information symbol above it. If the user clicks on one of the blue association lines, a window will appear displaying the data held on that association. Then if the user clicks “Associations” in the Legend 3420, that layer will be selected. Thereafter, the user may click the Selection tool in the menus and tool bars section 3410. Using a pointing device, such as a mouse, the user may click and drag a rectangle on the map that includes one or more association lines (e.g., blue lines). Any association line that passes within the rectangle will be highlighted in, for example, cyan. If the user clicks the Zoom-to-Select tool, the map will zoom in to a level that contains all the highlighted associations. Thereafter, if the user clicks the “View Table” button, a new window will appear with a table inside displaying all of the associations in the current project. The user will also notice that a few of the associations are highlighted in gray, for example. These are the highlighted associations on the map. The user may then close the “View Table” window. Thereafter, the user may click the Clear Selection tool, which will remove the cyan highlights on the map. Several additional features of the GIS have already been described above.

Building an Infrastructure Data Model

The present invention offers a flexible platform for evaluating networks of assets and entities based on different infrastructure data models. An infrastructure data model may be constructed that captures the nuances of a particular network so as to provide a comprehensive picture of that network. The first step in developing a data model for analyzing the network is to understand the problem to be addressed. This understanding should take into account the needs of a user, the particular time frame under consideration, and any other constraints (e.g., proprietary vs. nonproprietary).

Once the problem is defined at the right level of detail and the appropriate analysis tools are identified to address the problem, the second step in developing the infrastructure data model may be undertaken. This step involves researching and obtaining the appropriate infrastructure data. This step should take into account the availability, currency, accuracy and fidelity of the information.

Once the appropriate infrastructure data set(s) are acquired and any shortfalls taken into account, the third step in developing the infrastructure data model may be undertaken. This step involves building the appropriate infrastructure data model, which requires selection of the appropriate rules for application to the selected infrastructure data. These rules should take into account best practices, design models and methodologies, experience and country specific knowledge.

Once the data model is built, which involves preparing the infrastructure data so that the appropriate rules may be applied thereto, the final step in developing the infrastructure data model may be undertaken. This step involves validating the infrastructure data model using various network parameters. The validation step should test the model's feasibility and should be based on high confidence infrastructure data. It may be helpful to rely on interviews or an independent review in testing the infrastructure data model. The end of the validation step will involve updating the infrastructure data model as appropriate.

Although different embodiments of the present invention have been discussed, those skilled in the art will appreciate that variations may be made thereto without departing from the principles of the present invention. For example, although the invention has been described in connection with the use of a database, it may be appropriate to employ multiple databases to keep track of information relating to entities and assets. In addition, although the preferred embodiment has been described to include a number of features, an apparatus, method and computer readable medium may be designed which does not include all of those features, and yet still fall within the spirit and scope of the present invention.

### Contents of Compact Disc Appendix

The compact disc appendix filed herewith is a compact disc recordable (CD-R) contains the following files identified by name, size in bytes and date: TARGET Code CD

| File Name | Size | Date |
|---|---|---|
| CODE File | | |
| Application.cls | 32 KB | Feb. 24, 2003 |
| Asset.cls | 3 KB | Feb. 24, 2003 |
| AssetLink.cls | 2 KB | Feb. 24, 2003 |
| Assets.cls | 16 KB | Feb. 24, 2003 |
| Association.cls | 3 KB | Jan. 11, 2003 |
| Assocations.cls | 4 KB | Jan. 11, 2003 |
| CommDevice.cls | 3 KB | Oct. 4, 2002 |
| CommDevices.cls | 12 KB | Nov. 19, 2002 |
| Common.bas | 6 KB | Mar. 18, 2003 |
| Communication.cls | 3 KB | Nov. 19, 2002 |
| Communications.cls | 3 KB | Nov. 19, 2002 |
| frmAssetAdd.frm | 41 KB | Feb. 24, 2003 |
| frmAssetEdit.frm | 20 KB | Feb. 24, 2003 |
| frmAssetLinksAdd.frm | 5 KB | Oct. 15, 2002 |
| frmAssetLinksEdit.frm | 12 KB | Feb. 24, 2003 |
| frmAssetPerson.frm | 12 KB | Feb. 24, 2003 |
| frmChooseAsset.frm | 11 KB | Mar. 10, 2003 |
| frmChooseCommDevice.frm | 12 KB | Mar. 10, 2003 |
| frmChooseDir.frm | 3 KB | Mar. 18, 2003 |
| frmChoosePerson.frm | 13 KB | Mar. 10, 2003 |
| frmChooseProject.frm | 24 KB | Mar. 26, 2003 |
| frmChooseRole.frm | 1 KB | Oct. 14, 2002 |
| frmChooseSystem.frm | 9 KB | Oct. 4, 2002 |
| frmCommDeviceAdd.frm | 24 KB | Jan. 17, 2003 |
| frmCommDeviceEdit.frm | 11 KB | Jan. 17, 2003 |
| frmCommDevicePerson.frm | 14 KB | Jan. 17, 2003 |
| frmCommDeviceTypesEdit.frm | 6 KB | Jan. 17, 2003 |
| frmCommunication.frm | 8 KB | Nov. 18, 2002 |
| frmCommunicationAdd.frm | 10 KB | Jan. 17, 2003 |
| frmCommunicationEdit.frm | 10 KB | Jan. 17, 2003 |
| frmCommunicationList.frm | 7 KB | Jan. 17, 2003 |
| frmCommunicationWizard.frm | 10 KB | Jan. 17, 2003 |
| frmCountryOfOrigin.frm | 6 KB | Sep. 18, 2002 |
| frmCSV.frm | 22 KB | Mar. 18, 2003 |
| frmDebug.frm | 2 KB | Nov. 12, 2002 |
| frmExportMap.frm | 4 KB | Mar. 18, 2003 |
| frmImport.frm | 61 KB | Feb. 24, 2003 |
| frmInflowDir.frm | 2 KB | Jan. 17, 2003 |
| frmLegend.frm | 5 KB | Feb. 26, 2003 |
| frmMain.frm | 47 KB | Mar. 26, 2003 |
| frmMetricsEquation.frm | 10 KB | Mar. 26, 2003 |
| frmMetricTable.frm | 13 KB | Mar. 25, 2003 |
| frmPersonAlias.frm | 11 KB | Jan. 17, 2003 |
| frmPersonAsset.frm | 12 KB | Jan. 17, 2003 |
| frmPersonAssociations.frm | 24 KB | Mar. 13, 2003 |
| frmPersonCOI.frm | 7 KB | Nov. 19, 2002 |
| frmPersonCommDevice.frm | 14 KB | Jan. 17, 2003 |
| fimPersonEdit.frm | 15 KB | Jan. 17, 2003 |
| frmPersonRole.frm | 12 KB | Jan. 17, 2003 |
| frmPersonSystem.frm | 8 KB | Oct. 4, 2002 |
| frmProgress.frm | 1 KB | Nov. 13, 2002 |
| frmProjecAsset.frm | 13 KB | Nov. 14, 2002 |
| frmProject.frm | 43 KB | Mar. 26, 2003 |
| frmProjectAsset.frm | 20 KB | Jan. 17, 2003 |
| frmProjectEdit.frm | 7 KB | Jan. 17, 2003 |
| frmProjectNew.frm | 21 KB | Oct. 21, 2002 |
| frmProjectOD.frm | 20 KB | Nov. 14, 2002 |
| frmProjectold.frm | 31 KB | Oct. 17, 2002 |
| frmProjectPerson.frm | 22 KB | Jan. 17, 2003 |
| frmRoleAdd.frm | 1 KB | Oct. 14, 2002 |
| frmSplash2.frm | 11 KB | Mar. 11, 2003 |
| frmStartup.frm | 17 KB | Mar. 26, 2003 |
| frmSystem.frm | 2 KB | Sep. 12, 2002 |
| frmSystemAdd.frm | 7 KB | Oct. 4, 2002 |
| frmSystemEdit.frm | 4 KB | Sep. 18, 2002 |
| frmSystemEdit2.frm | 9 KB | Oct. 4, 2002 |
| frmSystemTypesEdit.frm | 5 KB | Oct. 4, 2002 |
| frmTable.frm | 26 KB | Feb. 27, 2003 |
| frmUserPrefs.frm | 8 KB | Mar. 18, 2003 |
| JMAAT.cls | 12 KB | Mar. 24, 2003 |
| Kamada.cls | 5 KB | Mar. 17, 2003 |
| Link.cls | 2 KB | Mar. 12, 2002 |
| Links.cls | 6 KB | Mar. 18, 2003 |
| MapProject.cls | 85 KB | Mar. 26, 2003 |
| Node.cls | 17 KB | Mar. 24, 2003 |
| Node_OLD.cls | 17 KB | Mar. 7, 2003 |
| Nodes.cls | 26 KB | Mar. 25, 2003 |
| Person.cls | 6 KB | Mar. 5, 2003 |
| Persons.cls | 24 KB | Mar. 13, 2003 |
| PersonsAssets.cls | 2 KB | Jan. 11, 2003 |
| Project.cls | 3 KB | Mar. 3, 2003 |
| Projects.cls | 21 KB | Mar. 4, 2002 |
| Role.cls | 2 KB | Oct. 14, 2002 |
| Roles.cls | 6 KB | Nov. 12, 2002 |
| SocialNetwork | 3 KB | Mar. 26, 2003 |
| System.cls | 3 KB | Oct. 4, 2002 |
| Systems.cls | 7 KB | Oct. 4, 2002 |
| TargetMain.vbp | 5 KB | Mar. 26, 2003 |
| TargetMain.vbw | 3 KB | Mar. 27, 2003 |
| Wizard.bas | 5 KB | Sep. 3, 2002 |
| Wizard.Dsr | 3 KB | Mar. 5, 2003 |
| Wizard.frm | 86 KB | Mar. 17, 2003 |

Research Bot File

| | | |
|---|---|---|
| grab_newsgroups.pl | 4 KB | Dec. 18, 2002 |
| grab_websites.pl | 6 KB | Dec. 6, 2002 |
| group_whois.pl | 5 KB | Dec. 18, 2002 |
| query_ebay.pl | 5 KB | Dec. 4, 2002 |
| query_google.pl | 5 KB | Dec. 4, 2002 |
| query_google_dir.pl | 5 KB | Nov. 22, 2002 |
| query_yahoo_dir.pl | 5 KB | Nov. 22, 2002 |
| rate_files.pl | 9 KB | Dec. 6, 2002 |
| run.pl | 10 KB | Dec. 18, 2002 |

1. An apparatus for evaluating a network of one or more entities and one or more assets, said apparatus comprising:
a memory storing information pertaining to at least a first entity in the network and at least a first asset in the network, the information including a first group of attributes corresponding to the first entity and a second group of attributes corresponding to the first asset, the first group of attributes including at least a first attribute identifying the first entity and a second attribute identifying a physical location of the first entity, the second group of attributes including a first attribute identifying the first asset and a second attribute identifying a physical location of the first asset;
a computer having a display, said computer being coupled to said memory, said computer being programmed to access said memory and retrieve at least a first subset of the information pertaining to the first entity and a second subset of the information pertaining to the first asset, the first subset of the information including at least the first group of attributes corresponding to the first entity, the second subset of the information including at least the second group of attributes corresponding to the first asset, the first subset of the information and the second subset of the information being retrieved from the memory in accordance with specified criteria;
wherein the computer is programmed to display one or more first indicia representative of the first subset of the information pertaining to the first entity and one or more second indicia representative of the second subset of the information pertaining to the first asset.

2. The apparatus defined by claim 1, wherein the first group of attributes corresponding to the first entity further includes a third attribute identifying at least one asset with which the first entity is linked, the asset being the first asset.

3. The apparatus defined by claim 1, wherein the second group of attributes corresponding to the first asset further includes a third attribute identifying at least one entity with which the first asset is linked, the entity being the first entity.

4. The apparatus defined by claim 1, wherein the information further pertains to a second entity in the network and a second asset in the network, the information including a third group of attributes corresponding to the second entity and a fourth group of attributes corresponding to the second asset, the third group of attributes including at least a first attribute identifying the second entity and a second attribute identifying a physical location of the second entity, the fourth group of attributes including a first attribute identifying the second asset and a second attribute identifying a physical location of the second asset;
wherein said computer is further programmed to access said memory and retrieve at least a third subset of the information pertaining to the second entity and a fourth subset of the information pertaining to the second asset, the third subset of the information including at least the third group of attributes corresponding to the second entity, the fourth subset of the information including at least the fourth group of attributes corresponding to the second asset, the third subset of the information and the fourth subset of the information being retrieved from the memory in accordance with specified criteria;
wherein said computer is further programmed to display one or more third indicia representative of the third subset of the information pertaining to the second entity and one or more fourth indicia representative of the fourth subset of information pertaining to the second asset.

5. The apparatus defined by claim 4, wherein the first group of attributes corresponding to the first entity further includes a third attribute identifying at least one asset with which the first entity is linked, the asset being one of the first asset and the second asset.

6. The apparatus defined by claim 5, wherein the third group of attributes corresponding to the second entity further includes a third attribute identifying at least one asset with which the third entity is linked, the asset being one of the first asset and the second asset.

7. The apparatus defined by claim 4, wherein the second group of attributes corresponding to the first asset further includes a third attribute identifying at least one entity with which the first asset is linked, the entity being the one of the first entity and the second entity.

8. The apparatus defined by claim 7, wherein the fourth group of attributes corresponding to the second asset further includes a third attribute identifying at least one entity with which the second asset is linked, the entity being the one of the first entity and the second entity.

9. The apparatus defined by claim 4, wherein the second group of attributes corresponding to the first asset further includes a third attribute identifying at least one other asset with which the first asset is linked, the one other asset being the second asset.

10. The apparatus defined by claim 4, wherein the first group of attributes corresponding to the first entity further includes one or more association attributes defining an association between the first entity and at least one other entity, the one other entity being the second entity.

11. The apparatus defined by claim 10, wherein the association attributes include an association attribute defining a type of the association between the first entity and the second entity.

12. The apparatus defined by claim 10, wherein the association attributes include an association attribute defining strength of the association between the first entity and the second entity.

13. The apparatus defined by claim 10, wherein the association attributes include an association attribute defining a direction type of the association between the first entity and the second entity, the direction type being one of the following: (i) a first direction from the first entity to the second entity, (ii) a second direction from the second entity to the first entity and (iii) both said first and second directions.

14. The apparatus defined by claim 10, wherein the association attributes include an association attribute providing a description of the type of the association between the first entity and the second entity.

15. The apparatus defined by claim 1, wherein the first attribute of the first group of attributes identifies the name of the first entity and the second attribute of the first group of attributes identifies a country of operation of the first entity.

16. The apparatus defined by claim 15, wherein the first group of attributes includes an additional attribute identifying a country of origin of the first entity.

17. The apparatus defined by claim 15, wherein the first group of attributes includes an additional attribute identifying a city in which the first entity is located.

18. The apparatus defined by claim 1, wherein the first group of attributes corresponding to the first entity further includes one or more of the following: an attribute identifying an alias of the first entity, an attribute identifying a role assumed by the first entity, an attribute identifying a classification status of the first entity, an attribute identifying a data source from which intelligence on the first entity was gathered, and an attribute providing descriptive information relating to the first entity.

19. The apparatus defined by claim 1, wherein the first attribute of the second group of attributes identifies the name of the first asset and the second attribute of the second group of attributes identifies a coordinate position of the first asset.

20. The apparatus defined by claim 15, wherein the coordinate position of the first asset is defined in terms of its latitude and longitude.

21. The apparatus defined by claim 1, wherein the second group of attributes corresponding to the first asset further includes one or more of the following: an attribute identifying a type of the first asset, and an attribute providing descriptive information relating to the first asset.

22. The apparatus defined by claim 4, wherein the first attribute of the third group of attributes identifies the name of the second entity and the second attribute of the third group of attributes identifies a country of operation of the second entity.

23. The apparatus defined by claim 22, wherein the third group of attributes includes an additional attribute identifying a country of origin of the second entity.

24. The apparatus defined by claim 22, wherein the [third] group of attributes includes an additional attribute identifying a city in which the second entity is located.

25. The apparatus defined by claim 4, wherein the third group of attributes corresponding to the second entity further includes one or more of the following: an attribute identifying an alias of the second entity, an attribute identifying a role assumed by the second entity, an attribute identifying a classification status of the second entity, an attribute identifying a data source from which intelligence on the second entity was gathered, and an attribute providing descriptive information relating to the second entity.

26. The apparatus defined by calim 4, wherein the first attribute of the fourth group of attributes identifies the name of the second asset and the second attribute of the fourth group of attributes identifies a coordinate position of the second asset.

27. The apparatus defined by claim 15, wherein the coordinate position of the second asset is defined in therms of its latitude and longitude.

28. The apparatus defined by claim 4, wherein the fourth group of attributes corresponding to the second asset further includes one or more of the following: an attribute identifying a type of the second asset, and an attribute providing descriptive information relating to the second asset.

29. The apparatus defined by claim 1, wherein said computer is programmed to display the one or more first indicia representative of the first subset of the information pertaining to the first entity and the one or more second indicia representative of the second subset of the information pertaining to the first asset in a plurality of virtual layers, wherein any number of layers of the plurality of virtual layers may be displayed on said display at any one time.

30. The apparatus defined by claim 29, wherein the plurality of virtual layers includes a first group of virtual layers having at least a first virtual layer, and wherein the one or more first indicia are displayed in the first group of virtual layers.

31. The apparatus defined by claim 30, wherein the first virtual layer of the first group of virtual layers displays one of the first indicia representing the second attribute of the first group of attributes included within the first subset of the information.

32. The apparatus defined by claim 30, wherein the plurality of virtual layers includes a second group of virtual layers having at least a first virtual layer, and wherein the one or more second indicia are displayed in the second group of virtual layers.

33. The apparatus defined by claim 32, wherein the first virtual layer of the first group of virtual layers is displayed one of the first indicia representing the second attribute of the first group of attributes included within the first subset of the information, and wherein the first virtual layer of the second group of virtual layers is displayed one of the second indicia representing the second attribute of the second group of attributes included within the second subset of the information.

34. The apparatus defined by claim 2, wherein said computer is programmed to display the one or more first indicia representative of the first subset of the information pertaining to the first entity and the one or more second indicia representative of the second subset of the information pertaining to the first asset in a plurality of virtual layers, wherein any number of layers of the plurality of virtual layers may be displayed on said display at any one time.

35. The apparatus defined by claim 34, wherein the plurality of virtual layers includes a first group of virtual layers having at least a first virtual layer, and wherein the one or more first indicia are displayed in the first group of virtual layers.

36. The apparatus defined by claim 35, wherein the first virtual layer of the first group of virtual layers is displayed one of the first indicia representing the second attribute of the first group of attributes included within the first subset of the information.

37. The apparatus defined by claim 35, wherein the plurality of virtual layers includes a second group of virtual layers having at least a first virtual layer, and wherein the one or more second indicia are displayed in the second group of virtual layers.

38. The apparatus defined by claim 37, wherein the first virtual layer of the first group of virtual layers is displayed one of the first indicia representing the second attribute of the first group of attributes included within the first subset of the information, and wherein the first virtual layer of the second group of virtual layers is displayed one of the second indicia representing the second attribute of the second group of attributes included within the second subset of the information.

39. The apparatus defined by claim 37, wherein the plurality of virtual layers includes a third group of virtual layers having at least a first virtual layer in which is displayed one of the first indicia representing the third attribute of the first group of attributes included within the first subset of the information.

40. The apparatus defined by claim 3, wherein said computer is programmed to display the one or more first indicia representative of the first subset of the information pertaining to the first entity and the one or more second indicia representative of the second subset of the information pertaining to the first asset in a plurality of virtual layers, wherein any number of layers of the plurality of virtual layers may be displayed on said display at any one time.

41. The apparatus defined by claim 40, wherein the plurality of virtual layers includes a first group of virtual layers having at least a first virtual layer, and wherein the one or more first indicia are displayed in the first group of virtual layers.

42. The apparatus defined by claim 41, wherein the first virtual layer of the first group of virtual layers is displayed one of the first indicia representing the second attribute of the first group of attributes included within the first subset of the information.

43. The apparatus defined by claim 41, wherein the plurality of virtual layers includes a second group of virtual layers having at least a first virtual layer, and wherein the one or more second indicia are displayed in the second group of virtual layers.

44. The apparatus defined by claim 43, wherein the first virtual layer of the first group of virtual layers is displayed one of the first indicia representing the second attribute of the first group of attributes included within the first subset of the information, and wherein the first virtual layer of the second group of virtual layers is displayed one of the second indicia representing the second attribute of the second group of attributes included within the second subset of the information.

45. The apparatus defined by claim 43, wherein the plurality of virtual layers includes a third group of virtual layers having at least a first virtual layer in which is displayed one of the second indicia representing the third attribute of the second group of attributes included within the second subset of the information.

46. The apparatus defined by claim 4, wherein said computer is programmed to display the one or more first indicia representative of the first subset of the information pertaining to the first entity, the one or more second indicia representative of the second subset of the information pertaining to the first asset, the one or more third indicia representative of the third subset of the information pertaining to the second entity and the one or more fourth indicia representative of the fourth subset of the information pertaining to the second asset in a plurality of virtual layers, wherein any number of layers of the plurality of virtual layers may be displayed on said display at any one time.

47. The apparatus defined by claim 46, wherein the plurality of virtual layers includes a first group of virtual layers having at least a first virtual layer, and wherein the one or more first indicia and the one or more third indicia are displayed in the first group of virtual layers.

48. The apparatus defined by claim 47, wherein the first virtual layer of the first group of virtual layers is displayed one of the first indicia representing the second attribute of the first group of attributes included within the first subset of the information and one of the third indicia representing the second attribute of the third group of attributes included within the third subset of information.

49. The apparatus defined by claim 46, wherein the plurality of virtual layers includes a second group of virtual layers having at least a first virtual layer, and wherein the one or more second indicia and the one or more fourth indicia are displayed in the second group of virtual layers.

50. The apparatus defined by claim 49, wherein the first virtual layer of the first group of virtual layers is displayed one of the first indicia representing the second attribute of the first group of attributes included within the first subset of the information and one of the third indicia representing the second attribute of the third group of attributes included within the third subset of information, and wherein the first virtual layer of the second group of virtual layers is displayed one of the second indicia representing the second attribute of the second group of attributes included within the second subset of the information and one of the fourth indicia representing the second attribute of the fourth group of attributes included within the fourth subset of the information.

51. The apparatus defined by claim 1, wherein one or more items of the information have a time stamp associated therewith.

52. The apparatus defined by claim 51, wherein the items include one or more attributes.

53. The apparatus defined by claim 4, wherein one or more items of the information have a time stamp associated therewith.

54. The apparatus defined by claim 53, wherein the items include one or more attributes.

55. The apparatus defined in claim 1, wherein the information is included within a database.

56. The apparatus defined in claim 4, wherein the information is included within a database.

57. A method for evaluating a network of one or more entities and one or more assets, said method comprising the acts of:
retrieving from a memory in accordance with specified criteria at least a first subset of information pertaining to a first entity in the network and a second subset of the information pertaining to a first asset in the network, the memory storing the information, which pertains to at least the first entity and at least the first asset, the information including a first group of attributes corresponding to the first entity and a second group of attributes corresponding to the first asset, the first group of attributes including at least a first attribute identifying the first entity and a second attribute identifying a physical location of the first entity, the second group of attributes including a first attribute identifying the first asset and a second attribute identifying a physical location of the first asset, the first subset of the information including at least the first group of attributes corresponding to the first entity, and the second subset of the information including at least the second group of attributes corresponding to the first asset; and
associating one or more first indicia with the first subset of the information pertaining to the first entity, the first indicia being representative of the first subset of the information pertaining to the first entity;
associating one or more second indicia with the second subset of the information pertaining to the first asset, the second indicia being representative of the second subset of information pertaining to the first asset; and
displaying the one or more first indicia and the one or more second indicia.

58. The method defined by claim 57, wherein the first group of attributes corresponding to the first entity further includes a third attribute identifying at least one asset with which the first entity is linked, the asset being the first asset.

59. The method defined by claim 57, wherein the second group of attributes corresponding to the first asset further includes a third attribute identifying at least one entity with which the first asset is linked, the entity being the first entity.

60. The method defined by claim 57, wherein the information further pertains to a second entity in the network and a second asset in the network, the information including a third group of attributes corresponding to the second entity and a fourth group of attributes corresponding to the second asset, the third group of attributes including at least a first attribute identifying the second entity and a second attribute identifying a physical location of the second entity, the fourth group of attributes including a first attribute identifying the second asset and a second attribute identifying a physical location of the second asset; and
wherein said method further comprises the acts of:
retrieving from the memory at least a third subset of the information pertaining to the second entity and a fourth subset of the information pertaining to the second asset, the third subset of the information including at least the third group of attributes corresponding to the second entity, the fourth subset of the information including at least the fourth group of attributes corresponding to the second asset, the third subset of the information and the fourth subset of the information being retrieved from the memory in accordance with specified criteria;
associating one or more third indicia with the third subset of the information pertaining to the second entity, the one or more third indicia being representative of the third subset of the information pertaining to the second entity;
associating one or more fourth indicia with the fourth subset of the information pertaining to the second asset, the one or more fourth indicia being representative of the fourth subset of the information pertaining to the second asset; and
displaying the one or more third indicia and the one or more fourth indicia.

61. The method defined by claim 60, wherein the first group of attributes corresponding to the first entity further includes a third attribute identifying at least one asset with which the first entity is linked, the asset being one of the first asset and the second asset.

62. The method defined by claim 61, wherein the third group of attributes corresponding to the second entity further includes a third attribute identifying at least one asset with which the third entity is linked, the asset being one of the first asset and the second asset.

63. The method defined by claim 60, wherein the second group of attributes corresponding to the first asset further includes a third attribute identifying at least one entity with which the first asset is linked, the entity being the one of the first entity and the second entity.

64. The method defined by claim 63, wherein the fourth group of attributes corresponding to the second asset further includes a third attribute identifying at least one entity with which the second asset is linked, the entity being the one of the first entity and the second entity.

65. The method defined by claim 60, wherein the second group of attributes corresponding to the first asset further includes a third attribute identifying at least one other asset with which the first asset is linked, the one other asset being the second asset.

66. The method defined by claim 60, wherein the first group of attributes corresponding to the first entity further includes one or more association attributes defining an association between the first entity and at least one other entity, the one other entity being the second entity.

67. The method defined by claim 66, wherein the association attributes include an association attribute defining a type of the association between the first entity and the second entity.

68. The method defined by claim 66, wherein the association attributes include an association attribute defining strength of the association between the first entity and the second entity.

69. The method defined by claim 66, wherein the association attributes include an association attribute defining a direction type of the association between the first entity and the second entity, the direction type being one of the following: (i) a first direction from the first entity to the second entity, (ii) a second direction from the second entity to the first entity and (iii) both said first and second directions.

70. The method defined by claim 66, wherein the association attributes include an association attribute providing a description of the type of the association between the first entity and the second entity.

71. The method defined by claim 57, wherein the first attribute of the first group of attributes identifies the name of the first entity and the second attribute of the first group of attributes identifies a country of operation of the first entity.

72. The method defined by claim 71, wherein the first group of attributes includes an additional attribute identifying a country of origin of the first entity.

73. The method defined by claim 71, wherein the first group of attributes includes an additional attribute identifying a city in which the first entity is located.

74. The method defined by claim 57, wherein the first group of attributes corresponding to the first entity further includes one or more of the following: an attribute identifying an alias of the first entity, an attribute identifying a role assumed by the first entity, an attribute identifying a classification status of the first entity, an attribute identifying a data source from which intelligence on the first entity was gathered, and an attribute providing descriptive information relating to the first entity.

75. The method defined by claim 57, wherein the first attribute of the second group of attributes identifies the name of the first asset and the second attribute of the second group of attributes identifies a coordinate position of the first asset.

76. The method defined by claim 71, wherein the coordinate position of the first asset is defined in terms of its latitude and longitude.

77. The method defined by claim 57, wherein the second group of attributes corresponding to the first asset further includes one or more of the following: an attribute identifying a type of the first asset, and an attribute providing descriptive information relating to the first asset.

78. The method defined by claim 60, wherein the first attribute of the third group of attributes identifies the name of the second entity and the second attribute of the third group of attributes identifies a country of operation of the second entity.

79. The method defined by claim 78, wherein the third group of attributes includes an additional attribute identifying a country of origin of the second entity.

80. The method defined by claim 78, wherein the first group of attributes includes an additional attribute identifying a city in which the second entity is located.

81. The method defined by claim 60, wherein the third group of attributes corresponding to the second entity further includes one or more of the following: an attribute identifying an alias of the second entity, an attribute identifying a role assumed by the second entity, an attribute identifying a classification status of the second entity, an attribute identifying a data source from which intelligence on the second entity was gathered, and an attribute providing descriptive information relating to the second entity.

82. The method defined by claim 60, wherein the first attribute of the fourth group of attributes identifies the name of the second asset and the second attribute of the fourth group of attributes identifies a coordinate position of the second asset.

83. The method defined by claim 71, wherein the coordinate position of the second asset is defined in terms of its latitude and longitude.

84. The method defined by claim 60, wherein the fourth group of attributes corresponding to the second asset further includes one or more of the following: an attribute identifying a type of the second asset, and an attribute providing descriptive information relating to the second asset.

85. The method defined by claim 57, wherein said act of displaying further comprises displaying the one or more first indicia and the one or more second indicia in a plurality of virtual layers, wherein any number of layers of the plurality of virtual layers may be displayed on said display at any one time.

86. The method defined by claim 85, wherein the plurality of virtual layers includes a first group of virtual layers having at least a first virtual layer, and wherein the one or more first indicia are displayed in the first group of virtual layers.

87. The method defined by claim 86, wherein the first virtual layer of the first group of virtual layers displays one of the first indicia representing the second attribute of the first group of attributes included within the first subset of the information.

88. The method defined by claim 86, wherein the plurality of virtual layers includes a second group of virtual layers having at least a first virtual layer, and wherein the one or more second indicia are displayed in the second group of virtual layers.

89. The method defined by claim 88, wherein the first virtual layer of the first group of virtual layers is displayed one of the first indicia representing the second attribute of the first group of attributes included within the first subset of the information, and wherein the first virtual layer of the second group of virtual layers is displayed one of the second indicia representing the second attribute of the second group of attributes included within the second subset of the information.

90. The method defined by claim 58, wherein said act of displaying further comprises displaying the one or more first indicia and the one or more second indicia in a plurality of virtual layers, wherein any number of layers of the plurality of virtual layers may be displayed on said display at any one time.

91. The method defined by claim 90, wherein the plurality of virtual layers includes a first group of virtual layers having at least a first virtual layer, and wherein the one or more first indicia are displayed in the first group of virtual layers.

92. The method defined by claim 91, wherein the first virtual layer of the first group of virtual layers is displayed one of the first indicia representing the second attribute of the first group of attributes included within the first subset of the information.

93. The method defined by claim 91, wherein the plurality of virtual layers includes a second group of virtual layers having at least a first virtual layer, and wherein the one or more second indicia are displayed in the second group of virtual layers.

94. The method defined by claim 93, wherein the first virtual layer of the first group of virtual layers is displayed one of the first indicia representing the second attribute of the first group of attributes included within the first subset of the information, and wherein the first virtual layer of the second group of virtual layers is displayed one of the second indicia representing the second attribute of the second group of attributes included within the second subset of the information.

95. The method defined by claim 93, wherein the plurality of virtual layers includes a third group of virtual layers having at least a first virtual layer in which is displayed one of the first indicia representing the third attribute of the first group of attributes included within the first subset of the information.

96. The method defined by claim 59, wherein said act of displaying further comprises displaying the one or more first indicia and the one or more second indicia in a plurality of virtual layers, wherein any number of layers of the plurality of virtual layers may be displayed on said display at any one time.

97. The method defined by claim 96, wherein the plurality of virtual layers includes a first group of virtual layers having at least a first virtual layer, and wherein the one or more first indicia are displayed in the first group of virtual layers.

98. The method defined by claim 97, wherein the first virtual layer of the first group of virtual layers is displayed one of the first indicia representing the second attribute of the first group of attributes included within the first subset of the information.

99. The method defined by claim 97, wherein the plurality of virtual layers includes a second group of virtual layers having at least a first virtual layer, and wherein the one or more second indicia are displayed in the second group of virtual layers.

100. The method defined by claim 99, wherein the first virtual layer of the first group of virtual layers is displayed one of the first indicia representing the second attribute of the first group of attributes included within the first subset of the information, and wherein the first virtual layer of the second group of virtual layers is displayed one of the second indicia representing the second attribute of the second group of attributes included within the second subset of the information.

101. The method defined by claim 99, wherein the plurality of virtual layers includes a third group of virtual layers having at least a first virtual layer in which is displayed one of the second indicia representing the third attribute of the second group of attributes included within the second subset of the information.

102. The method defined by claim 60, wherein said act of displaying further comprises displaying the one or more first indicia, the one or more second indicia, the one or more third indicia and the one or more fourth indicia, wherein any number of layers of the plurality of virtual layers may be displayed on said display at any one time.

103. The method defined by claim 102, wherein the plurality of virtual layers includes a first group of virtual layers having at least a first virtual layer, and wherein the one or more first indicia and the one or more third indicia are displayed in the first group of virtual layers.

104. The method defined by claim 103, wherein the first virtual layer of the first group of virtual layers is displayed one of the first indicia representing the second attribute of the first group of attributes included within the first subset of the information and one of the third indicia representing the second attribute of the third group of attributes included within the third subset of information.

105. The method defined by claim 102, wherein the plurality of virtual layers includes a second group of virtual layers having at least a first virtual layer, and wherein the one or more second indicia and the one or more fourth indicia are displayed in the second group of virtual layers.

106. The method defined by claim 105, wherein the first virtual layer of the first group of virtual layers is displayed one of the first indicia representing the second attribute of the first group of attributes included within the first subset of the information and one of the third indicia representing the second attribute of the third group of attributes included within the third subset of information, and wherein the first virtual layer of the second group of virtual layers is displayed one of the second indicia representing the second attribute of the second group of attributes included within the second subset of the information and one of the fourth indicia representing the second attribute of the fourth group of attributes included within the fourth subset of the information.

107. The method defined by claim 57, wherein one or more items of the information have a time stamp associated therewith.

108. The method defined by claim 107, wherein the items include one or more attributes.

109. The method defined by claim 60, wherein one or more items of the information have a time stamp associated therewith.

110. The method defined by claim 109, wherein the items include one or more attributes.

111. The method defined in claim 57, wherein the information is included within a database.

112. The method defined in claim 60, wherein the information is included within a database.

113. The method defined in claim 57, wherein the method further comprises the act of storing the information in the memory.

114. The method defined in claim 60, wherein the method further comprises the act of storing the information in the memory.

115. A computer-readable storage medium comprising instructions to facilitate evaluation of a network of one or more entities and one or more assets, the instructions being executable by a computer to perform the following acts:
retrieving from a memory in accordance with specified criteria at least a first subset of information pertaining to a first entity in the network and a second subset of the information pertaining to a first asset in the network, the memory storing the information, which pertains to at least the first entity and at least the first asset, the information including a first group of attributes corresponding to the first entity and a second group of attributes corresponding to the first asset, the first group of attributes including at least a first attribute identifying the first entity and a second attribute identifying a physical location of the first entity, the second group of attributes including a first attribute identifying the first asset and a second attribute identifying a physical location of the first asset, the first subset of the information including at least the first group of attributes corresponding to the first entity, and the second subset of the information including at least the second group of attributes corresponding to the first asset; and
associating one or more first indicia with the first subset of the information pertaining to the first entity, the one or more first indicia being representative of the first subset of the information pertaining to the first entity;
associating one or more second indicia with the second subset of the information pertaining to the first asset, the one or more second indicia being representative of the second subset of information pertaining to the first asset; and
displaying the one or more first indicia and the one or more second indicia.

116. The computer-readable storage medium defined by claim 115, wherein the first group of attributes corresponding to the first entity further includes a third attribute identifying at least one asset with which the first entity is linked, the asset being the first asset.

117. The computer-readable storage medium defined by claim 115, wherein the second group of attributes corresponding to the first asset further includes a third attribute identifying at least one entity with which the first asset is linked, the entity being the first entity.

118. The computer-readable storage medium defined by claim 115, wherein the information further pertains to a second entity in the network and a second asset in the network, the information including a third group of attributes corresponding to the second entity and a fourth group of attributes corresponding to the second asset, the third group of attributes including at least a first attribute identifying the second entity and a second attribute identifying a physical location of the second entity, the fourth group of attributes including a first attribute identifying the second asset and a second attribute identifying a physical location of the second asset; and
wherein the acts further include:
retrieving from the memory at least a third subset of the information pertaining to the second entity and a fourth subset of the information pertaining to the second asset, the third subset of the information including at least the third group of attributes corresponding to the second entity, the fourth subset of the information including at least the fourth group of attributes corresponding to the second asset, the third subset of the information and the fourth subset of the information being retrieved from the memory in accordance with specified criteria;
associating one or more third indicia with the third subset of the information pertaining to the second entity, the one or more third indicia being representative of the third subset of the information pertaining to the second entity;
associating one or more fourth indicia with the fourth subset of the information pertaining to the second asset, the one or more fourth indicia being representative of the fourth subset of the information pertaining to the second asset; and
displaying the one or more third indicia and the one or more fourth indicia.

119. The computer-readable storage medium defined by claim 118, wherein the first group of attributes corresponding to the first entity further includes a third attribute identifying at least one asset with which the first entity is linked, the asset being one of the first asset and the second asset.

120. The computer-readable storage medium defined by claim 119, wherein the third group of attributes corresponding to the second entity further includes a third attribute identifying at least one asset with which the third entity is linked, the asset being one of the first asset and the second asset.

121. The computer-readable storage medium defined by claim 118, wherein the second group of attributes corresponding to the first asset further includes a third attribute identifying at least one entity with which the first asset is linked, the entity being the one of the first entity and the second entity.

122. The computer-readable storage medium defined by claim 121, wherein the fourth group of attributes corresponding to the second asset further includes a third attribute identifying at least one entity with which the second asset is linked, the entity being the one of the first entity and the second entity.

123. The computer-readable storage medium defined by claim 118, wherein the second group of attributes corresponding to the first asset further includes a third attribute identifying at least one other asset with which the first asset is linked, the one other asset being the second asset.

124. The computer-readable storage medium defined by claim 118, wherein the first group of attributes corresponding to the first entity further includes one or more association attributes defining an association between the first entity and at least one other entity, the one other entity being the second entity.

125. The computer-readable storage medium defined by claim 124, wherein the association attributes include an association attribute defining a type of the association between the first entity and the second entity.

126. The computer-readable storage medium defined by claim 124, wherein the association attributes include an association attribute defining strength of the association between the first entity and the second entity.

127. The computer-readable storage medium defined by claim 124, wherein the association attributes include an association attribute defining a direction type of the association between the first entity and the second entity, the direction type being one of the following: (i) a first direction from the first entity to the second entity, (ii) a second direction from the second entity to the first entity and (iii) both said first and second directions.

128. The computer-readable storage medium defined by claim 124, wherein the association attributes include an association attribute providing a description of the type of the association between the first entity and the second entity.

129. The computer-readable storage medium defined by claim 115, wherein the first attribute of the first group of attributes identifies the name of the first entity and the second attribute of the first group of attributes identifies a country of operation of the first entity.

130. The computer-readable storage medium defined by claim 129, wherein the first group of attributes includes an additional attribute identifying a country of origin of the first entity.

131. The computer-readable storage medium defined by claim 129, wherein the first group of attributes includes an additional attribute identifying a city in which the first entity is located.

132. The computer-readable storage medium defined by claim 1115, wherein the first group of attributes corresponding to the first entity further includes one or more of the following: an attribute identifying an alias of the first entity, an attribute identifying a role assumed by the first entity, an attribute identifying a classification status of the first entity, an attribute identifying a data source from which intelligence on the first entity was gathered, and an attribute providing descriptive information relating to the first entity.

133. The computer-readable storage medium defined by claim 115, wherein the first attribute of the second group of attributes identifies the name of the first asset and the second attribute of the second group of attributes identifies a coordinate position of the first asset.

134. The computer-readable storage medium defined by claim 129, wherein the coordinate position of the first asset is defined in terms of its latitude and longitude.

135. The computer-readable storage medium defined by claim 115, wherein the second group of attributes corresponding to the first asset further includes one or more of the following: an attribute identifying a type of the first asset, and an attribute providing descriptive information relating to the first asset.

136. The computer-readable storage medium defined by claim 118, wherein the first attribute of the third group of attributes identifies the name of the second entity and the second attribute of the third group of attributes identifies a country of operation of the second entity.

137. The computer-readable storage medium defined by claim 136, wherein the third group of attributes includes an additional attribute identifying a country of origin of the second entity.

138. The computer-readable storage medium defined by claim 136, wherein the third group of attributes includes an additional attribute identifying a city in which the second entity is located.

139. The computer-readable storage medium defined by claim 118, wherein the third group of attributes corresponding to the second entity further includes one or more of the following: an attribute identifying an alias of the second entity, an attribute identifying a role assumed by the second entity, an attribute identifying a classification status of the second entity, an attribute identifying a data source from which intelligence on the second entity was gathered, and an attribute providing descriptive information relating to the second entity.

140. The computer-readable storage medium defined by claim 118, wherein the first attribute of the fourth group of attributes identifies the name of the second asset and the second attribute of the fourth group of attributes identifies a coordinate position of the second asset.

141. The computer-readable storage medium defined by claim 129, wherein the coordinate position of the second asset is defined in terms of its latitude and longitude.

142. The computer-readable storage medium defined by claim 118, wherein the fourth group of attributes corresponding to the second asset further includes one or more of the following: an attribute identifying a type of the second asset, and an attribute providing descriptive information relating to the second asset.

143. The computer-readable storage medium defined by claim 115, wherein said act of displaying further comprises displaying the one or more first indicia and the one or more second indicia in a plurality of virtual layers, wherein any number of layers of the plurality of virtual layers may be displayed on said display at any one time.

144. The computer-readable storage medium defined by claim 143, wherein the plurality of virtual layers includes a first group of virtual layers having at least a first virtual layer, and wherein the one or more first indicia are displayed in the first group of virtual layers.

145. The computer-readable storage medium defined by claim 144, wherein the first virtual layer of the first group of virtual layers displays one of the first indicia representing the second attribute of the first group of attributes included within the first subset of the information.

146. The computer-readable storage medium defined by claim 144, wherein the plurality of virtual layers includes a second group of virtual layers having at least a first virtual layer, and wherein the one or more second indicia are displayed in the second group of virtual layers.

147. The computer-readable storage medium defined by claim 146, wherein the first virtual layer of the first group of virtual layers is displayed one of the first indicia representing the second attribute of the first group of attributes included within the first subset of the information, and wherein the first virtual layer of the second group of virtual layers is displayed one of the second indicia representing the second attribute of the second group of attributes included within the second subset of the information.

148. The computer-readable storage medium defined by claim 116, wherein said act of displaying further comprises displaying the one or more first indicia and the one or more second indicia in a plurality of virtual layers, wherein any number of layers of the plurality of virtual layers may be displayed on said display at any one time.

149. The computer-readable storage medium defined by claim 148, wherein the plurality of virtual layers includes a first group of virtual layers having at least a first virtual layer, and wherein the one or more first indicia are displayed in the first group of virtual layers.

150. The computer-readable storage medium defined by claim 149, wherein the first virtual layer of the first group of virtual layers is displayed one of the first indicia representing the second attribute of the first group of attributes included within the first subset of the information.

151. The computer-readable storage medium defined by claim 149, wherein the plurality of virtual layers includes a second group of virtual layers having at least a first virtual layer, and wherein the one or more second indicia are displayed in the second group of virtual layers.

152. The computer-readable storage medium defined by claim 151, wherein the first virtual layer of the first group of virtual layers is displayed one of the first indicia representing the second attribute of the first group of attributes included within the first subset of the information, and wherein the first virtual layer of the second group of virtual layers is displayed one of the second indicia representing the second attribute of the second group of attributes included within the second subset of the information.

153. The computer-readable storage medium defined by claim 151, wherein the plurality of virtual layers includes a third group of virtual layers having at least a first virtual layer in which is displayed one of the first indicia representing the third attribute of the first group of attributes included within the first subset of the information.

154. The computer-readable storage medium defined by claim 117, wherein said act of displaying further comprises displaying the one or more first indicia and the one or more second indicia in a plurality of virtual layers, wherein any number of layers of the plurality of virtual layers may be displayed on said display at any one time.

155. The computer-readable storage medium defined by claim 154, wherein the plurality of virtual layers includes a first group of virtual layers having at least a first virtual layer, and wherein the one or more first indicia are displayed in the first group of virtual layers.

156. The computer-readable storage medium defined by claim 155, wherein the first virtual layer of the first group of virtual layers is displayed one of the first indicia representing the second attribute of the first group of attributes included within the first subset of the information.

157. The computer-readable storage medium defined by claim 155, wherein the plurality of virtual layers includes a second group of virtual layers having at least a first virtual layer, and wherein the one or more second indicia are displayed in the second group of virtual layers.

158. The computer-readable storage medium defined by claim 157, wherein the first virtual layer of the first group of virtual layers is displayed one of the first indicia representing the second attribute of the first group of attributes included within the first subset of the information, and wherein the first virtual layer of the second group of virtual layers is displayed one of the second indicia representing the second attribute of the second group of attributes included within the second subset of the information.

159. The computer-readable storage medium defined by claim 157, wherein the plurality of virtual layers includes a third group of virtual layers having at least a first virtual layer in which is displayed one of the second indicia representing the third attribute of the second group of attributes included within the second subset of the information.

160. The computer-readable storage medium defined by claim 118, wherein said act of displaying further comprises displaying the one or more first indicia, the one or more second indicia, the one or more third indicia and the one or more fourth indicia, wherein any number of layers of the plurality of virtual layers may be displayed on said display at any one time.

161. The computer-readable storage medium defined by claim 160, wherein the plurality of virtual layers includes a first group of virtual layers having at least a first virtual layer, and wherein the one or more first indicia and the one or more third indicia are displayed in the first group of virtual layers.

162. The computer-readable storage medium defined by claim 161, wherein the first virtual layer of the first group of virtual layers is displayed one of the first indicia representing the second attribute of the first group of attributes included within the first subset of the information and one of the third indicia representing the second attribute of the third group of attributes included within the third subset of information.

163. The computer-readable storage medium defined by claim 160, wherein the plurality of virtual layers includes a second group of virtual layers having at least a first virtual layer, and wherein the one or more second indicia and the one or more fourth indicia are displayed in the second group of virtual layers.

164. The computer-readable storage medium defined by claim 163, wherein the first virtual layer of the first group of virtual layers is displayed one of the first indicia representing the second attribute of the first group of attributes included within the first subset of the information and one of the third indicia representing the second attribute of the third group of attributes included within the third subset of information, and wherein the first virtual layer of the second group of virtual layers is displayed one of the second indicia representing the second attribute of the second group of attributes included within the second subset of the information and one of the fourth indicia representing the second attribute of the fourth group of attributes included within the fourth subset of the information.

165. The computer-readable storage medium defined by claim 118, wherein one or more items of the information have a time stamp associated therewith.

166. The computer-readable storage medium defined by claim 165, wherein the items include one or more attributes.

167. The computer-readable storage medium defined by claim 4, wherein one or more items of the information have a time stamp associated therewith.

168. The computer-readable storage medium defined by claim 167, wherein the items include one or more attributes.

169. The computer-readable storage medium defined in claim 115, wherein the information is included within a database.

170. The computer-readable storage medium defined in claim 118, wherein the information is included within a database.

171. The computer-readable storage medium defined in claim 115, wherein the acts further include storing the information in the memory.

172. The computer-readable storage medium defined in claim 118, wherein the acts further include storing the information in the memory.

173. A method for evaluating a network of one or more entities and one or more assets, said method comprising the acts of:
storing information in memory that is gathered with the aid of software program that searches a computer network;
retrieving from a memory in accordance with specified criteria at least a first subset of the information pertaining to a first entity in the network and a second subset of the information pertaining to a first asset in the network, the memory storing the information, which pertains to at least the first entity and at least the first asset, the information including a first group of attributes corresponding to the first entity and a second group of attributes corresponding to the first asset, the first group of attributes including at least a first attribute identifying the first entity and a second attribute identifying a physical location of the first entity, the second group of attributes including a first attribute identifying the first asset and a second attribute identifying a physical location of the first asset, the first subset of the information including at least the first group of attributes corresponding to the first entity, and the second subset of the information including at least the second group of attributes corresponding to the first asset; and
associating one or more first indicia with the first subset of the information pertaining to the first entity, the first indicia being representative of the first subset of the information pertaining to the first entity;
associating one or more second indicia with the second subset of the information pertaining to the first asset, the second indicia being representative of the second subset of information pertaining to the first asset; and
displaying the one or more first indicia and the one or more second indicia.
